(19) United States
(12) Patent Application Publication
(10) Pub. No.: US 2025/0237129 A1
(43) Pub. Date: Jul. 24, 2025

(54) HYDRAULIC FRACTURING METHODS UTILIZING COKE PROPPANT PARTICLES

(71) Applicant: ExxonMobil Technology and Engineering Company, Spring, TX (US)

(72) Inventors: Robert M. SHIRLEY, The Woodlands, TX (US); James S. BROWN, Sugar Land, TX (US); P. Matthew SPIECKER, Manvel, TX (US); Timothy G. BENISH, Spring, TX (US); Kyle B. GUICE, Houston, TX (US); Mohan G. KULKARNI, The Woodlands, TX (US)

(21) Appl. No.: 18/675,644

(22) Filed: May 28, 2024

Related U.S. Application Data
(63) Continuation-in-part of application No. 18/417,433, filed on Jan. 19, 2024, now abandoned.
(63) Continuation-in-part of application No. 18/417,478, filed on Jan. 19, 2024, now abandoned.
(63) Continuation-in-part of application No. 18/417,492, filed on Jan. 19, 2024, now abandoned.
(63) Continuation-in-part of application No. 18/417,488, filed on Jan. 19, 2024, now abandoned.
(63) Continuation-in-part of application No. 18/417,483, filed on Jan. 19, 2024, now abandoned.

(51) Int. Cl. E21B 43/267

(52) U.S. Cl. CPC E21B 43/267

(57) ABSTRACT

A method includes hydraulically fracturing a subterranean formation via a hydrocarbon well comprising a lateral section of at least 1,000 feet (305 meters) in length, a stage length of at least 200 feet (61 meters), and/or a cluster count of at least 6 perforation clusters per stage by introducing a fracturing fluid including a carrier fluid and coke proppant particles into the subterranean formation via a wellbore of the hydrocarbon well.

### CROSS-REFERENCE TO RELATED APPLICATION

This application claims priority to and the benefit of co-pending and commonly-assigned U.S. patent application Ser. No. 18/417,433, filed Jan. 19, 2024, titled “HYDRAULIC FRACTURING FLUID COMPRISING MICROPROPPANT COKE PARTICLES, METHOD FOR MAKING SAME, AND HYDRAULIC FRACTURING PROCESSES USING SAME,” co-pending and commonly-assigned U.S. patent application Ser. No. 18/417,478, filed Jan. 19, 2024, titled “METHODS FOR PERFORMING REFRACTURING OPERATIONS USING COKE PROPPANT PARTICLES,” co-pending and commonly-assigned U.S. patent application Ser. No. 18/417,492, filed Jan. 19, 2024, titled “PROPPANT PARTICLES FORMED FROM FLUID COKE AND FLEXICOKE, FRACTURING FLUIDS COMPRISING SUCH PROPPANT PARTICLES, AND METHODS RELATED THERETO,” co-pending and commonly-assigned U.S. patent application Ser. No. 18/417,488, filed Jan. 19, 2024, titled “HYDRAULIC FRACTURING METHODS UTILIZING COKE PROPPANT PARTICLES,” and co-pending and commonly-assigned U.S. patent application Ser. No. 18/417,483, filed Jan. 19, 2024, titled “METHODS FOR PRODUCING HYDROCARBON FLUIDS WITH REDUCED WATER-OIL RATIO BY UTILIZING OIL-WET PETROLEUM COKE PROPPANT PARTICLES DURING HYDRAULIC FRACTURING,” the contents of all of which are incorporated by reference herein in their entirety.

### FIELD

This disclosure relates generally to the field of hydraulic fracturing operations and proppant particles employed therein. More specifically, this disclosure relates to hydraulic fracturing methods utilizing coke proppant particles.

### BACKGROUND

This section is intended to introduce various aspects of the art, which may be associated with aspects and embodiments of the present disclosure. This discussion is believed to assist in providing a framework to facilitate a better understanding of particular aspects and embodiments of the present disclosure. Accordingly, it should be understood that this section should be read in this light, and not necessarily as admissions of prior art.

Difficulties often arise during hydraulic fracturing operations performed for hydrocarbon wells including long lateral sections, long stages, and/or high cluster counts. Such difficulties are particularly pronounced when non-coke proppants (e.g., sand) are utilized for such hydraulic fracturing operations since non-coke proppants have relatively high densities and high settling velocities and, therefore, do not transport effectively or uniformly throughout such long lateral sections, long stages, and/or high cluster counts. Therefore, there is a genuine need of high-performance proppants, hydraulic fracturing fluids, and hydraulic fracturing methods in the industry.

This disclosure satisfies these and other needs.

### SUMMARY

An aspect of the present disclosure provides a method, comprising hydraulically fracturing a subterranean formation via a wellbore comprising a lateral section of at least 1,000 feet (305 meters) in length, a stage length of at least 200 feet (61 meters), and/or a cluster count of at least 6 perforation clusters per stage by introducing a fracturing fluid comprising a carrier fluid and coke proppant particles into the subterranean formation via the wellbore. As described herein, such coke proppant particles may include but are not limited to fluid coke, flexicoke, delayed coke, thermally post-treated coke, pyrolysis coke, and/or coal-derived coke.

Another aspect of the present disclosure provides a hydrocarbon well, comprising: a wellbore that extends within a subterranean formation, where the wellbore comprises a lateral section of at least 1,000 feet (305 meters) in length as measured from a heel of the wellbore to a toe of the wellbore; a production casing string that extends within the lateral section of the wellbore; perforation clusters formed within the production casing string; hydraulic fractures formed in the subterranean formation proximate to the perforation clusters; and coke proppant particles positioned within at least a portion of the hydraulic fractures, where the at least the portion of the hydraulic fractures comprises one of the hydraulic fractures that is formed in the subterranean formation proximate to one of the perforation clusters that is closest to the toe the wellbore. In some embodiments, the lateral section is at least 10,000 feet (3,048 meters) in length.

Another aspect of the present disclosure provides a hydrocarbon well, comprising: a wellbore that extends within a subterranean formation; a production casing string that extends within at least a portion of the wellbore; a plurality of stages within the production casing string, where each of the plurality of stages comprises a stage length of at least 200 feet (61 meters); perforation clusters formed within each of the plurality of stages; hydraulic fractures formed in the subterranean formation proximate to the perforation clusters; and coke proppant particles positioned within at least a portion of the hydraulic fractures, where the at least the portion of the hydraulic fractures comprises one of the hydraulic fractures that is formed in the subterranean formation proximate to one of the perforation clusters that is furthest downstream within a corresponding stage. In some embodiments, the stage length is at least 400 feet (122 meters).

Another aspect of the present disclosure provides a hydrocarbon well, comprising: a wellbore that extends within a subterranean formation; a production casing string that extends within at least a portion of the wellbore; a plurality of stages within the production casing string; at least 6 perforation clusters formed within each of the plurality of stages; hydraulic fractures formed in the subterranean formation proximate to the perforation clusters; and coke proppant particles positioned within at least a portion of the hydraulic fractures, wherein the at least the portion of the hydraulic fractures comprises one of the hydraulic fractures that is formed in the subterranean formation proximate to one of the perforation clusters that is furthest downstream within a corresponding stage. In some embodiments, the hydrocarbon well comprises at least 10 perforation clusters formed within each of the plurality of stages.

These and other features and attributes of the disclosed aspects and embodiments of the present disclosure and their advantageous applications and/or uses will be apparent from the detailed description that follows.

### BRIEF DESCRIPTION OF THE DRAWINGS

To assist those of ordinary skill in the relevant art in making and using the subject matter described herein, reference is made to the appended drawings, where:

FIG. 1 is a graph comparing the apparent densities of petroleum coke particles within a petroleum coke sample to the apparent densities of sand particles within a sand sample;

FIG. 2 is a graph showing cumulative density functions for fluid coke particles within two fluid coke samples;

FIG. 3 is a graph showing particle size distributions for fluid coke particles within two fluid coke samples;

FIG. 4 is a bar graph showing the terminal settling velocities in recycled water for sand particles within a 40/70-mesh sand sample, sand particles within a 100-mesh sand sample, and fluid coke particles within a 100-mesh fluid coke sample;

FIG. 5 is a bar graph comparing the crush strengths of sand particles within a regional sand sample to the crush strengths of fluid coke particles within a fluid coke sample; and

FIG. 6 is a process flow diagram of an exemplary method for hydraulically fracturing a subterranean formation via a hydrocarbon well including a lateral section of at least 1,000 ft in length, a stage length of at least 200 ft, and/or a cluster count of at least 6 perforation clusters per stage using coke proppant particles in accordance with the present disclosure.

It should be noted that the figures are merely examples of the present disclosure and are not intended to impose limitations on the scope of the present disclosure. Further, the figures are generally not drawn to scale, but are drafted for purposes of convenience and clarity in illustrating various aspects of the present disclosure.

### DETAILED DESCRIPTION

In the following detailed description section, the specific examples of the present disclosure are described in connection with preferred aspects and embodiments. However, to the extent that the following description is specific to one or more aspects or embodiments of the present disclosure, this is intended to be for exemplary purposes only and simply provides a description of such aspect(s) or embodiment(s). Accordingly, the present disclosure is not limited to the specific aspects and embodiments described below, but rather, includes all alternatives, modifications, and equivalents falling within the true spirit and scope of the appended claims.

At the outset, and for ease of reference, certain terms used in this application and their meanings as used in this context are set forth. To the extent a term used herein is not defined below, it should be given the broadest definition those skilled in the art have given that term as reflected in at least one printed publication or issued patent. Further, the present disclosure is not limited by the usage of the terms shown below, as all equivalents, synonyms, new developments, and terms or processes that serve the same or a similar purpose are considered to be within the scope of the present claims.

As used herein, the singular forms “a,” “an,” and “the” mean one or more when applied to any embodiment described herein. The use of “a,” “an,” and/or “the” does not limit the meaning to a single feature unless such a limit is specifically stated.

The terms “about” and “around” mean a relative amount of a material or characteristic that is sufficient to provide the intended effect. The exact degree of deviation allowable in some cases may depend on the specific context, e.g., ±1%, ±5%, ±10%, ±15%, etc. It should be understood by those of skill in the art that these terms are intended to allow a description of certain features described and claimed without restricting the scope of these features to the precise numerical ranges provided. Accordingly, these terms should be interpreted as indicating that insubstantial or inconsequential modifications or alterations of the subject matter described are considered to be within the scope of the disclosure.

The term “and/or” placed between a first entity and a second entity means one of (1) the first entity, (2) the second entity, and (3) the first entity and the second entity. Multiple entities listed with “and/or” should be construed in the same manner, i.e., “one or more” of the entities so conjoined. Other entities may optionally be present other than the entities specifically identified by the “and/or” clause, whether related or unrelated to those entities specifically identified. Thus, as a non-limiting example, a reference to “A and/or B,” when used in conjunction with open-ended language such as “including,” may refer, in one embodiment, to A only (optionally including entities other than B); in another embodiment, to B only (optionally including entities other than A); in yet another embodiment, to both A and B (optionally including other entities). These entities may refer to elements, actions, structures, steps, operations, values, and the like.

As used herein, the term “any” means one, some, or all of a specified entity or group of entities, indiscriminately of the quantity.

As used herein, the term “apparent density,” with reference to the density of proppant particles, refers to the density of the individual particles themselves, which may be expressed in grams per cubic centimeter (g/cm³ or g/cc). The apparent density values provided herein are based on the American Petroleum Institute's Recommended Practice 19C (hereinafter “API RP-19C”) standard, entitled “Measurement of Properties of Proppants Used in Hydraulic Fracturing and Gravel-packing Operations” (First Ed. May 2008, Reaffirmed June 2016).

The phrase “at least one,” when used in reference to a list of one or more entities (or elements), should be understood to mean at least one entity selected from any one or more of the entities in the list of entities, but not necessarily including at least one of each and every entity specifically listed within the list of entities, and not excluding any combinations of entities in the list of entities. This definition also allows that entities may optionally be present other than the entities specifically identified within the list of entities to which the phrase “at least one” refers, whether related or unrelated to those entities specifically identified. Thus, as a non-limiting example, “at least one of A and B” (or, equivalently, “at least one of A or B,” or, equivalently, “at least one of A and/or B”) may refer, in one embodiment, to at least one, optionally including more than one, A, with no B present (and optionally including entities other than B); in another embodiment, to at least one, optionally including more than one, B, with no A present (and optionally including entities other than A); in yet another embodiment, to at least one, optionally including more than one, A, and at least one, optionally including more than one, B (and optionally including other entities). In other words, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” may mean A alone, B alone, C alone, A and B together, A and C together, B and C together, A, B, and C together, and optionally any of the above in combination with at least one other entity.

As used herein, the term “blast furnace coke” refers to any coal-derived coke suitable for use in a blast furnace for making steel.

As used herein, the term “crush strength,” when used with reference to proppant particles, refers to the uniaxial stress (compressive) load that the proppant particles can withstand prior to crushing (e.g., breaking or cracking). The crush strength values of the present disclosure are based on API RP-19C.

As used herein, the term “delayed coke” refers to the solid concentrated carbon material that is produced within delayed coking units via the delayed coking process. According to the delayed coking process, a preheated feedstock is introduced into a fractionator, where it undergoes a thermal cracking process in which long-chain hydrocarbons are split into shorter-chain hydrocarbons. The resulting lighter fractions are then removed as sidestream products. The fractionator bottoms, which include a recycle stream of heavy product, are heated in a furnace, which can have an outlet temperature of, e.g., around 895° F. to around 960° F. Exemplary outlet temperature ranges include around 900° F. to around 910° F., around 910° F. to around 920° F., around 920° F. to around 930° F., around 930° F. to around 940° F., around 940° F. to around 950° F., and around 950° F. to around 960° F., to name a few non-limiting examples. The heated feedstock then enters a reactor, often referred to as a “coke drum,” which can operate at temperatures of, e.g., around 780° F. to around 840° F. Exemplary ranges of reactor temperature include around 780° F. to around 790° F., around 790° F. to around 800° F., around 800° F. to around 810° F., around 810° F. to around 820° F., around 820° F. to around 830° F., and around 830° F. to around 840° F., to name a few non-limiting examples. Within the coke drum, the cracking reactions continue. The resulting cracked products then exit the coke drum as an overhead stream, while coke deposits in the coke drum. In general, this process is continued for a period of around 16 hours to around 24 hours to allow the coke drum to fill with coke. Exemplary ranges of specific cracking process times include around 16 hours to around 18 hours, around 18 hours to around 20 hours, around 20 hours to around 22 hours, and around 22 hours to around 24 hours, to name a few non-limiting examples. In addition, to allow the delayed coking unit to operate on a batch-continuous (or semi-continuous) basis, two or more coke drums are used. While one coke drum is on-line filling with coke, another coke drum can be steam-stripped, cooled, decoked (e.g., via hydraulically cutting the deposited coke with water), pressure-checked, and warmed up. Moreover, the overhead stream exiting the coke drum enters the fractionator, where naphtha and heating oil fractions are recovered. The heavy recycle material is then typically combined with preheated fresh feedstock and recycled back into the process.

As used herein, the terms “example,” exemplary,” and “embodiment,” when used with reference to one or more components, features, structures, or methods according to the present disclosure, are intended to convey that the described component, feature, structure, or method is an illustrative, non-exclusive example of components, features, structures, or methods according to the present disclosure. Thus, the described component, feature, structure, or method is not intended to be limiting, required, or exclusive/exhaustive; and other components, features, structures, or methods, including structurally and/or functionally similar and/or equivalent components, features, structures, or methods, are also within the scope of the present disclosure.

As used herein, the term “flexicoke” refers to the solid concentrated carbon material produced via the FLEXICOKING™ process, which is a thermal cracking process utilizing fluidized solids and gasification for the conversion of heavy, low-grade hydrocarbon feeds into lighter hydrocarbon products (e.g., upgraded, more valuable hydrocarbons). Briefly, the FLEXICOKING™ process integrates a cracking reactor, a heater, and a gasifier into a common fluidized-solids (coke) circulating system. A feed stream (of residua) is fed into a fluidized bed, along with a stream of hot recirculating material to the reactor. From the reactor, a stream containing coke is circulated to the heater vessel, where it is heated. The hot coke stream is sent from the heater to the gasifier, where it reacts with air and steam. The gasifier product gas, referred to as coke gas, containing entrained coke particles, is returned to the heater and cooled by cold coke from the reactor to provide a portion of the reactor heat requirement, which is typically in a range from around 496° C. to around 538° C. Exemplary ranges of reactor heat that may be used include around 496° C. to around 500° C., around 500° C. to around 510° C., around 510° C. to around 520° C., around 520° C. to around 530° C., around 530° C. to around 538° C., to name a few non-limiting examples. A return stream of coke sent from the gasifier to the heater provides the remainder of the heat requirement. The coke meeting the heat requirement is then circulated to the reactor, and the feed stream is thermally cracked to produce light hydrocarbon liquids that are removed from the reactor and recovered using conventional fractionating equipment. Fluid coke is formed from the thermal cracking process and settles (deposits) onto the “seed” fluidized bed coke already present in the reactor. The resultant at least partially gasified coke is flexicoke. In some instances, the coke from the thermal cracking process deposits in a pattern that appears ring-like atop the surface of the seed coke. Flexicoke is continuously withdrawn from the system during normal FLEXICOKING™ processing (e.g., from the reactor or after it is streamed to the heater via an elutriator) to ensure that the system maintains particles of coke in a fluidizable particle size range. Accordingly, flexicoke is a readily available byproduct of the FLEXICOKING™ process.

Relatedly, the terms “wet flexicoke fines” and “dry flexicoke fines” refer to two byproducts of the FLEXICOKING™ process. Such byproducts are collected as particles that were not recovered in the secondary cyclones of the heater. More specifically, the particles are collected first in the tertiary cyclone as dry flexicoke fines, and the smaller particles that travel past the tertiary cyclone are then recovered in the venturi scrubber as wet flexicoke fines.

As used herein, the term “fluid coke” refers to the solid concentrated carbon material remaining from fluid coking. The term “fluid coking” refers to a thermal cracking process utilizing fluidized solids for the conversion of heavy, low-grade hydrocarbon feeds into lighter products (e.g., upgraded hydrocarbons), producing fluid coke as a byproduct. The fluid coking process differs from the FLEXICOKING™ process that produces the Flexicoke in that the fluid coking process does not include a gasifier.

As used herein, the term “fly ash” refers to fine particles of ash, dust, and soot that generally consist primarily of silicon dioxide, aluminum oxide, and calcium oxide and are produced as a byproduct of the combustion of pulverized coal, typically within coal-fired electric and steam-generating plants.

The term “fracture” (or “hydraulic fracture”) refers to a crack or surface of breakage within a subterranean formation, that can be induced by an applied pressure or stress.

As used herein, the term “hydraulic conductivity” refers to the ability of a fluid within a subterranean formation to pass through a fracture including proppant at various stress (or pressure) levels, which is based, at least in part, on the permeability of the proppant deposited within the hydraulic fractures. The hydraulic conductivity values provided herein are based on the American Petroleum Institute's Recommended Practice 19D (API RP-19D) standard, entitled “Measuring the Long-Term Conductivity of Proppants” (First Ed. May 2008, Reaffirmed May 2015).

As used herein, the term “limited-entry,” when used with reference to completion methods for hydrocarbon wells, refers to any suitable completion methods that provide for a pressure drop of at least 500 psi across the perforations to provide greater uniformity of fracturing fluid distribution among the perforation clusters within each stage. Relatedly, the term “extreme-limited-entry,” when used with reference to completion methods for hydrocarbon wells, refers to any suitable completion methods that provide for a pressure drop of at least 2,000 psi across the perforations to provide greater uniformity of fracturing fluid distribution among the perforation clusters within each stage.

As used herein, the term “metallurgical coke” refers to a type of coal-derived coke that is produced by heating coal, which causes fixed carbon to fuse to inherent ash and drives off a large percentage of the volatile matter. The resulting metallurgical coke particles include a range of different sizes, with the smallest particles being a fine powder (sometimes referred to as “coke breeze”).

The term “particle size(s),” when used herein with reference to a type of particles,” refers to the diameter(s) of such particle(s). The term “particle size distribution,” when used herein with reference to a type or a collection of particles, refers to the range of diameters for such particles, typically from the minimal to the maximal. The terms “average particle size distribution” and “D50” when used herein with reference to a type or a collection of particles, interchangeably mean the median particle size of the particles.

The term “petroleum coke” refers to a final carbon-rich solid material that is derived from oil refining. More specifically, petroleum coke is the carbonization product of high-boiling hydrocarbon fractions that are obtained as a result of petroleum processing operations. Petroleum coke is produced within a coking unit via a thermal cracking process in which long-chain hydrocarbons are split into shorter-chain hydrocarbons. As described herein, there are at least three main types of petroleum coke: delayed coke, fluid coke, and flexicoke. Each type of petroleum coke is produced using a different coking process; however, all three coking processes have the common objective of maximizing the yield of distillate products within a refinery by rejecting large quantities of carbon in the residue as petroleum coke.

The term “coal-derived coke” means any coke prepared from coal by, e.g., thermal treatment.

As used herein, the terms “proppant” and “proppant particle” refer to a solid material capable of maintaining open an induced fracture during and following a hydraulic fracturing treatment. The term “proppant pack” refers to a collection of proppant particles.

The terms “coke proppant” and “coke proppant particles” refer to a proppant based on or derived from a solid carbonaceous material produced from treating a carbon-containing material (e.g., oil (e.g., crude oil, vacuum pipestill, and the like), coal, and hydrocarbons) at an elevated temperature in an oxygen deficient environment. The elevated temperature can be at least 200, 250, 300, 350; 400, 450, 500, 600, 700, 800, 900, or even 1000° C. The carbonaceous material comprises the carbon element and optionally additional elements including but not limited to hydrogen, sulfur, vanadium, iron, and the like. The carbonaceous material preferably comprises the carbon element at a concentration of ≥50 wt %, e.g., from 50, 55, 60, 65, 70, wt %, to 75, 80, 85, 90, 95 wt %, to 96, 97, 98, 99 wt %, or even 100 wt %, based on the total weight of all elements in the carbonaceous material.

The carbonaceous material preferably comprises the carbon element and hydrogen element at a combined concentration of ≥55 wt %, e.g., from 55, 60, 65, 70, wt %, to 75, 80, 85, 90, 95 wt %, to 96, 97, 98, 99 wt %, or even 100 wt %, based on the total weight of all elements in the carbonaceous material.

The term “non-coke proppant” means any proppant that does not comprise coke proppant particles. Examples of non-coke proppant include sand, ceramic proppants, glass proppants, and polymer proppants.

The term “lightweight proppant (LWP)” refers to proppants having an apparent density within a range of from around 1.2 g/cm³ to around 2.2 g/cm³ (e.g., from around 1.2, 1.3, 1.4, 1.5, 1.6 g/cm³ to around 1.7, 1.8, 1.9, 2.0, 2.1, 2.2 g/cm³), while the term “ultra-lightweight proppant (ULWP)” refers to proppants having an apparent density within a range from around 0.5 g/cm³ to around 1.2 g/cm³ (e.g., from around 0.5, 0.6, 0.7, 0.8 g/cm³ to around 0.9, 1.0, 1.1, 1.2 g/cm³). A coke proppant may or may not be an LWP. The term “non-LWP proppant” refers to proppants having apparent density higher than 2.2 g/cm³ (e.g., from around 2.3, 2.4, 2.5 to around 2.6, 2.8, 3.0, to 3.2, 3.4, 3.5 g/cm³.) A non-coke proppant may or may not be a non-LWP.

The term “microproppant coke particles” means a collection of coke proppant particles having particle sizes of at most 105 μm, but potentially within a range from around 0.0001 μm to 105 μm (e.g., from around 0.0001, 0.001, 0.01, 0.1 μm to 0.5, 1.0, 2.0, 5.0, 8.0 10 μm, to 15, 20, 25, 30, 35, 40, 45 μm, to 50, 53, 55, 60, 63, 65 μm, to 74, 75, 80, 85, 88, 90, 95, 100, 105 μm). The term “petroleum coke fines” means a collection of microproppant coke particles that are derived from a petroleum source material.

As used herein, the term “pyrolysis coke” refers to a type of coke that is generated via hydrocarbon pyrolysis at temperatures higher than the coking processes for making petroleum coke.

The term “substantially,” when used in reference to a quantity or amount of a material, or a specific characteristic thereof, refers to an amount that is sufficient to provide an effect that the material or characteristic was intended to provide. The exact degree of deviation allowable may depend, in some cases, on the specific context.

The term “substantially free” or “essentially free” when used with reference to a component of a composition, interchangeably means that the composition comprises the component at a concentration of ≤10 wt %, ≤5 wt %, ≤3 wt %, ≤1 wt %, or 0 wt %, based on the total weight of the composition, depending on the details of the particular implementation.

As used herein, the term “thermally post-treated coke” refers to petroleum coke that has been heated to temperatures in a range from around 400° C. to 1200° C. for a predetermined duration that is in a range from around 1 minute to around 24 hours.

The term “wellbore” refers to a borehole drilled into a subterranean formation. The borehole may include vertical, deviated, highly deviated, and/or lateral sections. The term “wellbore” also includes the downhole equipment associated with the borehole, such as the casing strings, production tubing, gas lift valves, and other subsurface equipment. Relatedly, the term “hydrocarbon well” (or simply “well”) includes the wellbore in addition to the wellhead and other associated surface equipment.

Certain embodiments and features are described herein using a set of numerical upper limits and a set of numerical lower limits. It should be appreciated that ranges from any lower limit to any upper limit are contemplated unless otherwise indicated. All numerical values are “about”, “around,” or “approximately” the indicated value, and account for experimental errors and variations that would be expected by a person having ordinary skill in the art.

During the drilling of a hydrocarbon well, a wellbore is formed within a subterranean formation using a drill bit that may be advanced at the lower end of a drill string until it reaches a predetermined location in the subsurface. The drill string and bit may then be removed, and the wellbore may be lined with steel tubulars, commonly referred to as casing strings. An annulus may thus be formed between the casing strings and the surrounding subterranean formation. A cementing operation may be conducted to fill the annulus with columns of cement. The combination of the casing strings and the cement strengthens the wellbore and isolates or impedes fluid flow and pressure transmissibility along the annulus.

It is common to place several casing strings having progressively-smaller outer diameters into the wellbore. The first casing string may be referred to as the “surface casing string.” The surface casing string serves to isolate and protect the shallower, freshwater-bearing aquifers from contamination by any other wellbore fluids. Accordingly, this casing string may be cemented entirely back to the surface.

A process of drilling and then cementing progressively-smaller casing strings may be repeated several times below the surface casing string until the hydrocarbon well has reached total depth. The final casing string, referred to as the “production casing string,” may extend through a hydrocarbon-bearing interval (referred to as a “reservoir”) in the subterranean formation. In some instances, the production casing string is a production liner, that is, a casing string that is not tied back to the surface. The production casing string may also be cemented into place. In some completions, the production casing string has swell packers or plugs spaced across selected productive intervals. This creates compartments between the packers for isolation of stages and specific stimulation treatments. In this instance, the annulus may simply be packed with sand.

As part of the completion process, a section of the wellbore (referred to as a “stage”) may be isolated through the setting of a packer or plug. The production casing string may then be perforated at one or more desired intervals uphole of the plug, meaning that clusters of perforations are created through the production casing string and the cement column surrounding the production casing string using a perforating gun. In operation, the perforating gun may form one perforation cluster by shooting a number of perforations in close proximity, such as, for example, 12 to 18 perforations at one time, over a 1 foot (ft) (0.3 meter (m)) to 3 ft (0.9 m) region, for example, with each perforation potentially being approximately 0.3 inches (in) (0.8 centimeters (cm)) to 0.5 in (1.3 cm) in diameter, for example. The perforating gun may then be moved uphole around 10 ft (3 m) to 100 ft (30 m), for example, and a second perforating gun may be used to form a second perforation cluster. This process of forming perforation clusters may be repeated to create additional perforation clusters within each stage of the hydrocarbon well. The resulting perforation clusters may allow hydrocarbon fluids from the surrounding subterranean formation to flow into the hydrocarbon well. Note that in some instances, however, the production casing string is instead provided as a sliding sleeve tubular or other type of casing string with pre-formed perforation clusters. In such instances, the preformed perforations may be initially closed but can be opened through various forms of actuation to control fluid flow through the perforations.

After the perforation process is complete, the subterranean formation may be hydraulically fractured at each stage of the wellbore to increase the productivity of the subterranean formation. Hydraulic fracturing consists of injecting a volume of fracturing fluid through the created perforations and into the surrounding subterranean formation at such high pressures and rates that the subsurface rock in proximity to the perforations cracks open and resulting hydraulic fractures extend outwardly into the subterranean formation in proportion to the injected fluid volume. Ideally, a separate hydraulic fracture emanates outwardly from each perforation cluster, forming a set of hydraulic fractures, commonly referred to as a “fracture network.” Ideally, this fracture network includes a sequence of parallel fracture planes, thereby creating as much fracturing of the subsurface rock as possible. Near the wellbore, a complex topology of hydraulic fractures may sometimes result from the breakdown of perforations within each perforation cluster, but it is common to assume that these hydraulic fractures ultimately link up to form a single dominant fracture plane that is hydraulically connected to the wellbore. In operation, to create the hydraulic fracture, the injection pressure of the fracturing fluid must exceed the hydraulic pressure in the subterranean formation plus the strength of the rock, and often even exceeds the lithostatic pressure in the subterranean formation.

Hydraulic fracturing is used most extensively for increasing the productivity of “unconventional” (or “tight”) subterranean formations, which are subterranean formations with very low permeability that typically do not produce economically without hydraulic fracturing. Examples of unconventional subterranean formations include tight sandstone formations, tight carbonate formations, shale gas formations, coal bed methane formations, and tight oil formations. During the hydraulic fracturing of such subterranean formations, the pump rate (or injection rate) of the fracturing fluid may be increased until it reaches a maximum pump rate of around 20 barrels per minute (bbl/min) (0.05 cubic meters per second (m³/s)) to around 150 bbl/min (0.41 m³/s) (e.g., 20, 40, 60, 80, 100, 120, 140, 150 bbl/min). In operation, around 5,000 barrels (795 m³) to around 15,000 barrels (2,385 m³) (e.g., 5,000, 6,000, 7,000, 8,000, 9,000, 10,000, 11,000, 12,000, 13,000, 14,000, 15,000 barrels) of fracturing fluid may be injected for each stage of the hydrocarbon well, for example.

In operation, a small portion (e.g., often around 5% to around 10%) of the fracturing fluid may be pumped into the wellbore during a pad phase of the hydraulic fracturing operation for each stage. The pad phase is designed to initiate hydraulic fractures and grow the hydraulic fractures to a certain size and volume to accommodate the injection of a proppant, such as sand, crushed granite, ceramic beads, or other granular materials (which are generally referred to herein as “non-coke proppants”). The remaining portion of the fracturing fluid may then be mixed with the proppant and pumped into the wellbore and through the perforations into the stimulated reservoir volume (SRV). The proppant serves to hold the hydraulic fractures open after the hydraulic pressure is released. Ideally, the resulting hydraulic fractures grow to be hundreds of feet radially from the wellbore into the subterranean formation. In the case of unconventional subterranean formations, the combination of hydraulic fractures and injected proppant substantially increases the flow capacity of the treated formation.

This application of hydraulic fracturing is a routine part of petroleum industry operations as applied to individual subterranean formations. Such subterranean formations may represent hundreds of feet of gross, vertical thickness of subterranean formation. More recently, hydrocarbon wells are being completed through subterranean formations laterally, with the lateral sections often extending for at least 1,000 ft (305 m). Such hydrocarbon wells are sometimes referred to as “extended-reach lateral hydrocarbon wells” or, for some cases in which the lateral sections extend for at least 10,000 ft (3,048 m), “ultra-extended-reach lateral hydrocarbon wells.” The completion of hydrocarbon wells with such extensive lateral sections provides a number of potential advantages, including providing a larger resulting SRV and therefore a corresponding increase in production performance, as well as reducing the total number of hydrocarbon wells that are to be drilled to effectively drain a given section of the subterranean formation. However, the completion of such hydrocarbon wells typically involves more complex treatment techniques to obtain treatment of the entire target area. As part of such treatment techniques, various stages of the wellbore may be isolated (as described above) to ensure that each separate stage is not only perforated, but also adequately hydraulically fractured. In this way, the fracturing fluid that is injected for each stage of interest is able to more efficiently flow through the corresponding perforation clusters and into the subterranean formation, effectively increasing the hydraulic conductivity of the hydraulic fractures at each desired depth and lateral location. Moreover, treatment of a stage of interest may involve isolating the stage from all stages that have already been treated. This often involves the use of so-called diversion materials, which cause the injected fracturing fluid to be directed towards one selected stage of interest while being diverted from other stages. For example, in many cases, plugs are set between stages and are used to prevent injected fracturing fluid from entering stages that have already been hydraulically fractured and propped.

This hydraulic fracturing process may be repeated for every stage in the hydrocarbon well. In the case of hydrocarbon wells including lateral sections, the first stage is located near the end (or “toe”) of the lateral section, and the last stage is typically located near the beginning (or “heel”) of the lateral section.

After the hydraulic fracturing process is complete, the plugs (and/or other diversion materials) may be drilled out of the wellbore as part of a wellbore cleanout procedure. The hydrocarbon well may then be brought on production, meaning that it may be used to recover hydrocarbon fluids from the subterranean formation. In operation, the pressure differential between the subterranean formation and the hydrocarbon well is typically used to force hydrocarbon fluids to flow through the hydraulic fractures in the subterranean formation and into the production casing string via the corresponding perforation clusters. The hydrocarbon fluids then flow up the wellbore to the surface.

In operation, the success of the hydraulic fracturing operation has a direct impact on the ultimate production performance of the hydrocarbon well. However, despite the utilization of the complex treatment techniques described above, difficulties often arise during hydraulic fracturing operations performed for hydrocarbon wells including such long lateral sections. In particular, it is challenging to extend the perforating gun and other downhole equipment far enough into the wellbore of such a hydrocarbon well to effectively treat the stages located closer to the toe of the lateral section of the wellbore. In addition, the hydraulic fracturing of a subterranean formation via such a hydrocarbon well suffers from inefficiencies due to the inability to uniformly distribute non-coke proppants across the various stages, including, in particular, the stages located closer to the toe of the lateral section of the wellbore. Moreover, it can be challenging to fully clean out the wellbore of such a hydrocarbon well due to the extensive length of the lateral section. In some cases, dissolvable plugs (and/or other dissolvable, biodegradable, and/or self-destructible diversion materials) are run into the wellbore with the expectation that such plugs (and/or other diversion materials) will disappear without performing a cleanout procedure. However, even in such cases, cleanout is often still performed since sand bridges form around the plugs (and/or other diversion materials), blocking flow from downstream of the plugs (and/or other diversion materials) and therefore preventing the plugs (and/or other diversion materials) from effectively flowing out of the wellbore.

Furthermore, in recent years, attention has increasingly turned to the completion of hydrocarbon wells with longer stages and/or higher cluster counts (where the term “cluster count” refer to the number of perforation clusters per stage). More specifically, while hydrocarbon wells have historically been completed with stages lengths of around 25 ft to around 100 ft and around 3 clusters per stage, more recent techniques have focused on completing hydrocarbon wells with stage lengths of at least 200 ft and/or relatively high cluster counts of at least 6. The completion of hydrocarbon wells with such long stages and/or high cluster counts provides a number of potential advantages, including reducing the time and cost for the overall completion process, reducing the number of wireline runs during the completion process, and decreasing the likelihood of tools becoming stuck in the wellbore. However, difficulties are often encountered during the hydraulic fracturing of subterranean formations via hydrocarbon wells including such long stages and/or high cluster counts. In particular, in order to effectively treat such long stages, more perforation clusters may be included within each stage as compared to stages with shorter stage lengths. Moreover, even when the stage length is not particularly long, the cluster spacing may be reduced such that the cluster count is still relatively high. However, the utilization of such high cluster counts (either alone or in conjunction with longer stages) results in a lower flow rate for the fracturing fluid flowing into each perforation cluster and, by extension, a lower ability for the proppant within the fracturing fluid to transport deeply into the hydraulic fractures. This issue is particularly pronounced when non-coke proppants are utilized since such non-coke proppants have relatively high densities and high settling velocities and, therefore, will often settle within the near-wellbore region of the hydraulic fractures without coming within proximity to the tips of such hydraulic fractures.

To combat such hydraulic fracturing difficulties with respect to hydrocarbon wells including relatively long lateral sections, relatively long stages, and/or relatively high cluster counts, limited-entry and extreme-limited-entry methods have been utilized in recent years to improve the uniformity of fracturing fluid (and therefore proppant) distribution across the lateral sections, the stages, and/or the perforation clusters. In particular, limited-entry and extreme-limited-entry methods are designed to provide pressure drops of at least 500 pounds per square inch (psi) and at least 2,000 psi, respectively, across the perforations. However, such limited-entry and extreme-limited-entry methods have had limited success in increasing the treatment uniformity for such hydrocarbon wells. Specifically, because the erosive properties of non-coke proppants are particularly pronounced at such large pressure differentials, erosion within the wellbore (e.g., particularly erosion of the stages and/or perforation clusters located further upstream or towards the heel) typically interferes with the flow of the fracturing fluid (e.g., particularly flow into the more remote regions of long lateral sections and/or the stages and/or perforation clusters located further downstream or towards the toe), thereby negating the potential advantages of such limited-entry and extreme-limited-entry methods.

Therefore, the present disclosure alleviates the foregoing difficulty and provides related advantages as well. Specifically, the present disclosure provides for the hydraulic fracturing of subterranean formations via hydrocarbon wells including long lateral sections of at least 1,000 ft in length, long stages of at least 200 ft in length, or high cluster counts of at least 6 perforation clusters per stage (or any combination of such features) using coke proppant particles. More specifically, according to the present disclosure, coke proppant particles are provided as at least a portion of the proppant particles within a fracturing fluid, and such fracturing fluid is then introduced into a subterranean formation via a wellbore of a hydrocarbon well that includes a lateral section of at least 1,000 ft in length, a stage length of greater 200 ft, and/or a cluster count of at least 6 perforation clusters per stage as part of a hydraulic fracturing operation with respect to such well.

The coke proppant particles include a number of properties and features that alleviate the aforementioned difficulties that are typically encountered during the hydraulic fracturing of subterranean formations via such hydrocarbon wells. First, with respect to the hydraulic fracturing of subterranean formations via hydrocarbon wells including lateral sections of at least 1,000 ft in length, the lower-density nature of coke enables coke proppant particles to transport further within the wellbore and the corresponding hydraulic fractures as compared to non-coke proppant particles, as described further herein. In addition, coke proppant particles have been shown to be less prone than non-coke proppant particles to flow back into the wellbore once the hydraulic fracturing operation is complete and the hydrocarbon well is brought on production. Moreover, coke proppant particles are expected to be less prone than non-coke proppant particles to settle around the diversion materials within the wellbore, thus enabling dissolvable, biodegradable, or self-destructible diversion materials (such as dissolvable plugs, for example) to be effectively used within the wellbore. Furthermore, the utilization of coke proppant particles reduces the likelihood of cluster-level screen-out as compared to the utilization of non-coke proppant particles. Each of these factors may advantageously reduce or eliminate the need to perform a wellbore cleanout procedure and/or may enable the completion of wellbores with longer lateral sections in a more cost-effective and efficient manner. Additionally, assuming that a wellbore cleanout procedure is still performed, the ability of coke proppant particles to remain suspended in a fluid (e.g., water) for a longer period of time than non-coke proppants facilitates a faster, more efficient cleanout procedure for wellbores with longer lateral sections.

Second, with respect to the hydraulic fracturing of subterranean formations via hydrocarbon wells with long stages of at least 200 ft in length and/or high cluster counts of at least 6 perforation clusters per stage, the lower-density nature of coke particles, such as, in particle, petroleum coke particles, enables coke proppant particles to transport further within each stage and/or further throughout the large number of perforation clusters as compared to non-coke proppant particles. As a result, fracturing fluids including coke proppant particles will more evenly and efficiently flow throughout relatively long stages and/or into relatively large numbers of perforation clusters and, therefore, also more efficiently travel into the tips (or at least within proximity to the tips) of the formed hydraulic fractures.

Moreover, the utilization of a fracturing fluid including the coke proppant particles described herein enables limited-entry and extreme-limited-entry methods to be more efficiently utilized for hydrocarbon wells including long lateral sections of at least 1,000 ft in length, long stages of at least 200 ft in length, and/or high cluster counts of at least 6 perforation clusters per stage. Specifically, because coke is expected to be much less erosive than sand and other types of non-coke proppants, the utilization of coke proppant particles as at least a portion of the proppant within the fracturing fluid enables the efficient performance of limited-entry and extreme-limited-entry methods that are not highly successful using sand and other types of non-coke proppants. In particular, while sand erosion is particularly pronounced at the large pressure differentials used for limited-entry and extreme-limited-entry methods, coke provides a less erosive alternative that enables the maintenance of substantial flow uniformity across the relatively long lateral sections, the relatively long stages, and/or the relatively large numbers of perforation clusters of such wellbores. More specifically, the utilization of coke proppant particles for limited-entry and/or extreme-limited-entry methods performed with respect to hydrocarbon wells including lateral sections that are at least 1,000 ft in length combats the wellbore friction and accompanying erosion that typically compromise the efficient flow of fracturing fluid into stages that are located closer to the toe of the lateral section of the wellbore. Moreover, the utilization of coke proppant particles for limited-entry and/or extreme-limited-entry methods performed with respect to hydrocarbon wells with long stages that are at least 200 ft in length and/or high cluster counts of at least 6 perforation clusters per stage combats the perforation erosion that typically compromises the efficient flow of fracturing fluid into perforation clusters that are located further downstream within each stage of the wellbore.

With regard to the utilization of petroleum coke as a proppant during hydraulic fracturing operations, petroleum coke has sufficient crush strength to maintain propped fractures upon the removal of hydraulic pressure and to maintain efficient conductivity once the wellbore is brought on production. In addition, the relatively low density of petroleum coke may decrease or eliminate the need to use gelled fracturing fluids, thereby avoiding the costs associated with gelation. Furthermore, using petroleum coke may potentially reduce required injection pressures, reduce overall water consumption, and avoid the need for frequent wellbore cleanouts.

Effective proppant particles are typically associated with a variety of particular characteristics or properties, including efficient proppant particle transport within a carrier fluid, sufficient strength to maintain propped fractures upon the removal of hydraulic pressure, and efficient conductivity once the wellbore is brought on production. With respect to the proppant particle transport properties, the settling rate of a proppant particle within a fracturing fluid at least in part determines its transport capacity within a hydraulic fracture. The settling rate of a proppant particle can be determined using Equation (1).

$$v = \frac{{ρ}_{p} - {ρ}_{f}}{18 η} g {σ}^{2} , \qquad ( 1 )$$

In Equation (1), v is the proppant particle, ρₚ-ρ_{f} is proportional to the density difference between the proppant particle and the carrier fluid, η is the viscosity of the carrier fluid, g is the gravitational constant, and σ² is proportional to the square of the proppant particle size. As will be appreciated, proppant particles having lower apparent densities and/or smaller particle sizes settle at a slower rate within an identical carrier fluid (thus having better transport) compared to higher apparent density and/or larger particle sized proppant particles.

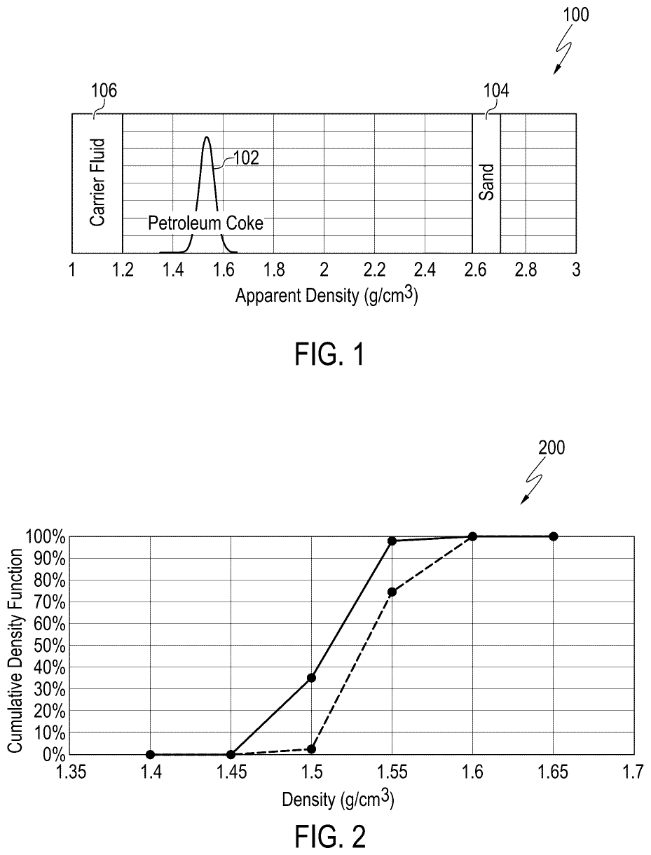

Petroleum coke is therefore particularly well-suited for utilization as a proppant during hydraulic fracturing operations due at least in part to the relatively low apparent densities of petroleum coke particles as compared to non-coke proppants (e.g., sand). This is illustrated by FIG. 1, which is a graph 100 comparing the apparent densities of petroleum coke particles within a petroleum coke sample to the apparent densities of sand particles within a sand sample. Specifically, the apparent densities of the petroleum coke particles (i.e., in this example, fluid coke particles) and the sand particles were determined in the laboratory by measuring the mass of each type of particle that settled in a given density of brine. Based on these measurements, the apparent densities of the petroleum coke particles ranged from around 1.3 g/cm³ to around 1.7 g/cm³ (e.g., from around 1.3, 1.4, 1.5 g/cm³ to around 1.6, 1.7 g/cm³), as shown at 102, while the apparent densities of the sand particles ranged from around 2.6 g/cm³ to around 2.7 g/cm³, as shown at 104. Therefore, the apparent density of petroleum coke is significantly lower than the apparent density of sand. Moreover, the apparent density of typical carrier fluid (e.g., water) generally ranges from around 1.0 g/cm³ to around 1.2 g/cm³, as shown at 106. Moreover, FIG. 2 is a graph 200 showing cumulative density functions for fluid coke particles within two fluid coke samples. As shown, the densities of the fluid coke particles ranged from around 1.4 g/cm³ to around 1.65 g/cm³ (e.g., from around 1.4, 1.45, 1.5, 1.5 g/cm³ to around 1.6, 1.65 g/cm³).

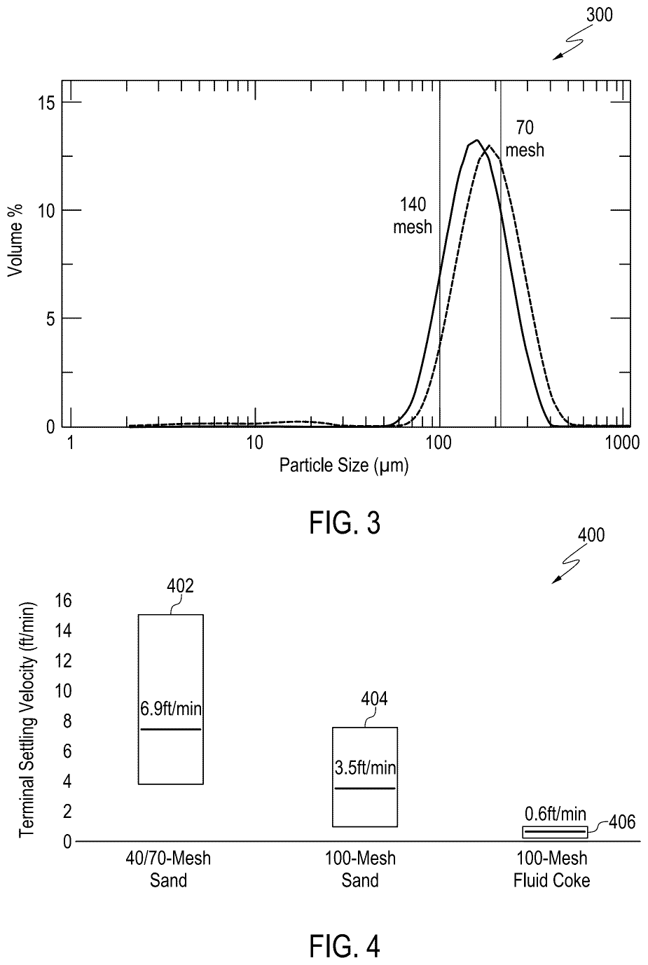

The transport properties of coke proppant particles are further enhanced by the differentiated size distribution of such particles. Specifically, while the particle sizes of sand generally ranges from around 105 microns (μm) to around 850 μm (i.e., around 140 mesh to around 20 mesh), the particle size of petroleum coke can be varied such that it either approximates the particle size of sand or is provided with smaller particle sizes. As an example, FIG. 3 is a graph 300 showing particle size distributions for fluid coke particles within two fluid coke samples. As shown, the particle sizes for the two fluid coke samples were from around 100 μm to around 210 μm (i.e., around 140 mesh to around 70 mesh), which encompasses the lower end of the range of typical particle sizes for different types of sand. Moreover, as described further herein, petroleum coke particles may also be provided with much smaller particle sizes via the utilization of microproppant coke particles, which may have particle sizes of at most 105 μm (140 mesh) or, in some cases, at most than 88 μm (170 mesh), but potentially within a range from around 0.0001 μm to 105 μm (e.g., from around 0.0001, 0.001, 0.01, 0.1 μm to 0.5, 1.0, 2.0, 5.0, 8.0 10 μm, to 15, 20, 25, 30, 35, 40, 45 μm, to 50, 53, 55, 60, 63, 65 μm, to 74, 75, 80, 85, 88, 90, 95, 100, 105 μm).

As described above with respect to Equation (1), because petroleum coke particles have lower apparent densities and similar or smaller particle sizes as compared to non-coke proppants (e.g., sand), such petroleum coke particles also have lower settling rates within the carrier fluid and, therefore, have enhanced transport properties as compared to sand. This is illustrated by FIG. 4, which is a bar graph 400 showing the terminal settling velocities in recycled water for sand particles within a 40/70-mesh sand sample, sand particles within a 100-mesh sand sample, and fluid coke particles within a 100-mesh fluid coke sample. In particular, the average terminal settling velocity for the sand particles within the 40/70-mesh sand sample was 6.9 feet per minute (ft/min), as shown at 402; the average terminal settling velocity for the sand particles within the 100-mesh sand sample was 3.5 ft/min, as shown at 404; and the average terminal settling velocity for the fluid coke particles within the 100-mesh fluid coke sample was 0.6 ft/min, as shown at 406. Therefore, fluid coke particles (which are representative of other types of petroleum coke particles) will clearly transport further into hydraulic fractures than sand particles. As a result, proppants formed at least in part from petroleum coke are capable of propping extended regions of new and/or existing hydraulic fractures that would not be effectively propped by non-coke proppants, thus increasing the overall SRV in the subterranean formation and leading to increased production performance for the corresponding hydrocarbon well.

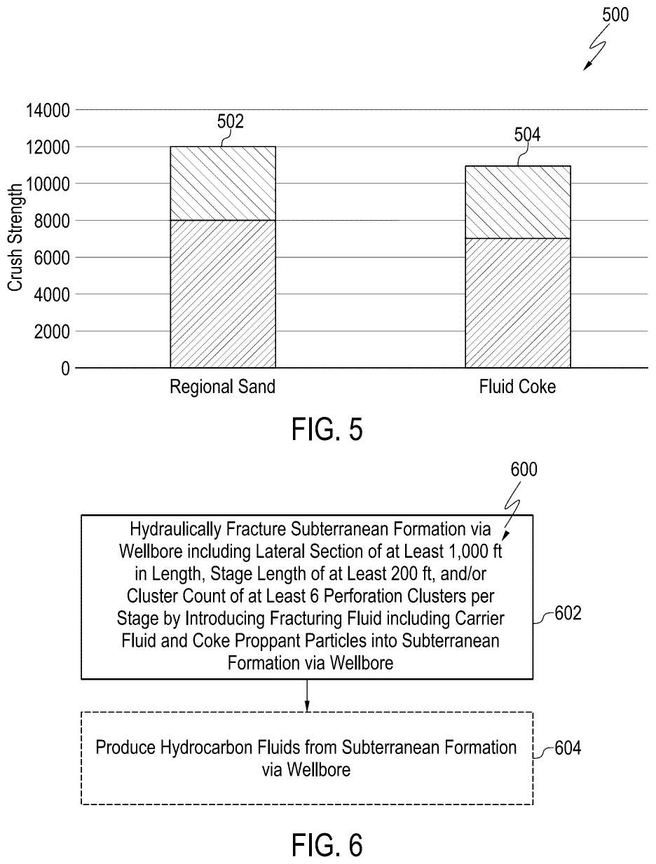

Furthermore, the crush strength of a proppant particle is a measure of the particle's ability to withstand stresses within a hydraulic fracture, with efficient proppant particles being capable of resisting sustained loads within hydraulic fractures during the lifetime of the corresponding wellbore without comprising the hydraulic conductivity of such hydraulic fractures. As a result, proppant particles with higher crush strengths are favorable. According to API RP-19C standards, adequate proppant particles should have a crush strength indicating that less than 10% of fines are produced under a stress of 5,000 psi. In this regard, the crush strength of petroleum coke is advantageously comparable to the crush strength of sand. This is illustrated by FIG. 5, which is a bar graph 500 comparing the crush strengths of sand particles within a regional sand sample, as shown at 502, to the crush strengths of fluid coke particles within a fluid coke sample, as shown at 504. Such crush strength was determined according to API K crush strength testing by applying stress to the respective particles in increments of 1,000 psi until 10% fines were formed, with the crush strength of the particles within each sample being the pressure (in psi) at which 10% fines were formed. As shown in FIG. 5, the crush strength of fluid coke (which is representative of other types of petroleum coke) is comparable to the crush strength of regional sand.

With regard to the erosive properties of petroleum coke particles as compared to sand particles, it is noted that sand particles have a hardness of around 7 on the Mohs hardness scale, while petroleum coke particles have a hardness of less than around 6 on the Mohs hardness scale. Therefore, petroleum coke particles are expected to be less erosive than sand particles and are less likely to cause substantial erosion within the production causing string, including, in particular, the erosion of the perforation clusters.

Any suitable type(s) of petroleum coke and/or other type(s) of coke may be used for the coke proppant particles described herein. For example, the coke proppant particles may include but are not limited to fluid coke particles, flexicoke particles, delayed coke particles, thermally post-treated coke particles, pyrolysis coke particles, coal-derived coke particles (e.g., blast furnace coke particles and/or metallurgical coke particles), microproppant coke particles, or any combination thereof.

For embodiments in which flexicoke particles are utilized as at least a portion of the coke proppant particles described herein, such flexicoke particles are produced via the FLEXICOKING™ process. Briefly, the FLEXICOKING™ process integrates a cracking reactor, a heater, and a gasifier into a common fluidized-solids (coke) circulating system. A feed stream (of residua) is fed into a fluidized bed, along with a stream of hot recirculating material to the reactor. From the reactor, a stream containing coke is circulated to the heater vessel, where it is heated. The hot coke stream is sent from the heater to the gasifier, where it reacts with air and steam. The gasifier product gas, referred to as coke gas, containing entrained coke particles, is returned to the heater and cooled by cold coke from the reactor to provide a portion of the reactor heat requirement. A return stream of coke sent from the gasifier to the heater provides the remainder of the heat requirement. The coke meeting the heat requirement is then circulated to the reactor, and the feed stream is thermally cracked to produce light hydrocarbon liquids that are removed from the reactor and recovered using conventional fractionating equipment. Fluid coke is formed from the thermal cracking process and settles (deposits) onto the “seed” fluidized bed coke already present in the reactor. The resultant at least partially gasified coke is flexicoke. In some instances, the coke from the thermal cracking process deposits in a pattern that appears ring-like atop the surface of the seed coke. Flexicoke is continuously withdrawn from the system during normal FLEXICOKING™ processing (e.g., from the reactor or after it is streamed to the heater via an elutriator) to ensure that the system maintains particles of coke in a fluidizable particle size range. Accordingly, flexicoke is a readily available byproduct of the FLEXICOKING™ process.

The gasification process of FLEXICOKING™ results in substantial concentration of metals in the flexicoke product and additionally allows for operational desulfurization of sulfur from the flexicoke. The gasification can be minimized or maximized to influence the sulfur content (minimization=lower sulfur content). Accordingly, unlike cokes formed in other processes, flexicoke has a comparatively high metal content and a comparatively lower sulfur content that can be manipulated.

In various embodiments, the flexicoke particles may have a carbon content that is in a range from around 85 weight percent (wt %) to around 99 wt % (e.g., around 85, 86, 87, 88, 89, 90, 91, 92, 93, 94, 95, 96, 97, 98 or 99 wt %); a weight ratio of carbon to hydrogen that is in a range from around 80:1 to around 95:1 (e.g., around 80:1, 82:1, 84:1, 86:1, 88:1, 90:1, 92:1, 94:1 or 95:1); and an impurities content (i.e., a weight percent of all components other than carbon and hydrogen) that is in a range from around 1 wt % to around 10 wt % (e.g., around 1, 2, 3, 4, 5, 6, 7, 8, 9 or 10 wt %). Flexicoke also has a higher metal content than other cokes. In particular, the flexicoke particles may have a combined vanadium and nickel content that is in a range from around 3,000 parts per million (ppm) to around 45,000 ppm (e.g. around 3,000, 5,000, 10,000, 15,000, 20,000 ppm to 25,000, 25,000, 30,000, 35,000, 40,000, 45,000 ppm). In addition, the flexicoke particles may have a sulfur content that is in a range from 0 wt % to around 5 wt %, as well as a nitrogen content that is in a range from 0 wt % to around 3 wt %.

The apparent density of the flexicoke particles may be in a range from around 1.0 g/cm³ to around 2.0 g/cm³ (e.g., from around 1.0, 1.1, 1.2, 1.3, 1.4, 1.5 g/cm³ to around 1.7, 1.8, 1.9, 2.0 g/cm³). Traditional sand-based proppants generally have apparent densities of at least around 2.5 g/cm³. Thus, the flexicoke particles have substantially lower apparent densities compared to non-coke, sand-based proppants, which is indicative of their comparably more effective transport and lower settling rates within a fracture formed as part of a hydraulic fracturing operation.

For embodiments in which fluid coke particles are utilized as at least a portion of the coke proppant particles described herein, such fluid coke particles are obtained via a fluid coking process. Generally-speaking, flexicoke is considered to be a type (or subset) of fluid coke. Therefore, as expected, the fluid coke particles include a number of the same (or similar) characteristics as flexicoke. However, the fluid coking process may be manipulated in various ways to produce fluid coke particles having a number of distinctive characteristics. For example, the fluid coke particles may have a carbon content that is in a range from around 75 wt % to around 93 wt % (e.g., around 75, 76, 77, 78, 79, 80, 81, 82, 83, 84, 85, 86, 87, 88, 89, 90, 91, 92 or 93 wt %); a weight ratio of carbon to hydrogen that is in a range from around 30:1 to around 50:1 (e.g., around 30:1, 32:1, 34:1, 36:1, 38:1, 40:1, 42:1, 44:1, 46:1, 48:1 or 50:1); and an impurities content that is in a range from around 5 wt % to around 25 wt % (e.g., around 5, 7, 9, 11, 13, 15, 17, 19, 21, 23 or 25 wt %). The fluid coke particles may also have a sulfur content that is in a range from around 3 wt % to around 10 wt % (e.g., around 3, 4, 5, 6, 7, 8, 9 or 10 wt %), as well as a nitrogen content that is in a range from around 0.5 wt % to around 3.0 wt % (e.g., around 0.5, 1.0, 1.5, 2.0, 2.5 or 3.0 wt %. In addition, the apparent density of the fluid coke particles may be in a range from around 1.4 g/cm³ to around 2.0 g/cm³ (e.g., around 1.4, 1.5, 1.6, 1.7, 1.8, 1.9 or 2.0 g/cm³).

For embodiments in which delayed coke particles are utilized as at least a portion of the coke proppant particles described herein, such delayed coke particles are produced within a delayed coking unit via a delayed coking process. According to the delayed coking process, a preheated feedstock is introduced into a fractionator, where it undergoes a thermal cracking process in which long-chain hydrocarbons are split into shorter-chain hydrocarbons. The resulting lighter fractions are then removed as sidestream products. The fractionator bottoms, which include a recycle stream of heavy product, are heated in a furnace, which typically has an outlet temperature that is in a range from around 480° C. to around 515° C. (e.g., around 480, 485, 490, 500, 505, 510, 515° C., to name a few non-limiting examples). The heated feedstock then enters a reactor, referred to as a “coke drum,” which typically operates at temperatures that are in a range from around 415° C. to around 450° C. (e.g., around 415, 420, 425, 430, 435, 440, 445, 450° C., to name a few non-limiting examples). Within the coke drum, the cracking reactions continue. The resulting cracked products then exit the coke drum as an overhead stream, while coke deposits on the inner surface of the coke drum. In general, this process is continued for a period of around 16 hours to around 24 hours (e.g., around 16, 17, 18, 19, 20, 21, 22, 23, 24 hours, to name a few non-limiting examples) to allow the coke drum to fill with coke. In addition, to allow the delayed coking unit to operate on a batch-continuous (or semi-continuous) basis, two or more coke drums are typically used. While one coke drum is on-line filling with coke, the other coke drum is being steam-stripped, cooled, decoked (e.g., via hydraulically cutting the deposited coke with water), pressure-checked, and warmed up. Moreover, the overhead stream exiting the coke drum enters the fractionator, where naphtha and heating oil fractions are recovered. The heavy recycle material is then typically combined with preheated fresh feedstock and recycled back into the process.

The delayed coke particles may exhibit the following properties: (1) a carbon content that is in a range from around 82 wt % to around 90 wt % (e.g., around 82, 83, 84, 85, 86, 87, 88, 89, 90 wt %); (2) a weight ratio of carbon to hydrogen that is in a range from around 15:1 to around 30:1 (e.g., around 15:1, 16:1, 18:1, 20:1, 22:1, 24:1, 26:1, 28:1 or 30:1); (3) a combined vanadium and nickel content that is in a range from around 100 ppm to around 3,000 ppm (e.g. 100, 500, 1,000, 1,500, 2,000, 2,500, 3,000 ppm); (4) a sulfur content that is in a range from around 2 wt % to around 8 wt % (e.g., around 2, 3, 4, 5, 6, 7, 8 wt %); and/or (5) a nitrogen content that is in a range from around 1 wt % to around 2 wt % (e.g., 1.0, 1.1, 1.2, 1.3, 1.4, 1.5, 1.6, 1.7, 1.8, 1.9 or 2.0 wt %), where such properties are measured on a dry, ash-free basis (or, in other words, not counting residual ash content and removing moisture before the analysis). In addition, the delayed coke particles may have a moisture content that is in a range from around 6 wt % to around 14 wt % (e.g., around 6, 7, 8, 9, 10, 11, 12, 13, 14 wt %) and a volatile matter content that is in a range from around 6 wt % to around 18 wt % (e.g., 6, 7, 8, 9, 10, 11, 12, 13, 14, 15, 16, 17, 18 wt %), as measured on an as-received basis. Moreover, the apparent density of the delayed coke particles may be in a range from around 1.0 g/cm³ to around 1.7 g/cm³ (e.g., around 1.0, 1.1, 1.2, 1.3, 1.4, 1.5, 1.6, 1.7 g/cm³). Furthermore, the crush strength of the delayed coke particles may be comparable to the crush strengths of other types of petroleum coke particles.

For embodiments in which microproppant coke particles are utilized as at least a portion of the coke proppant particles described herein, such microproppant coke particles may include wet flexicoke fines and/or dry flexicoke fines produced as a byproduct of the FLEXICOKING™ process. Additionally or alternatively, the microproppant coke particles may include sieved fluid coke, sieved flexicoke, sieved delayed coke, sieved thermally post-treated coke, sieved pyrolysis coke, and/or sieved coal-derived coke (e.g., sieved blast furnace coke and/or sieved metallurgical coke). Additionally or alternatively, in some embodiments, the microproppant coke particles may include ground fluid coke, ground flexicoke, ground delayed coke, ground thermally post-treated coke, ground pyrolysis coke, and/or ground coal-derived coke (e.g., ground blast furnace coke and/or ground metallurgical coke). Moreover, any other suitable types of microproppant coke particles may be additionally or alternatively utilized.

With respect to the utilization of microproppant coke particles including wet and/or dry flexicoke fines as at least a portion of the coke proppant particles described herein, such flexicoke fines are byproducts of the FLEXICOKING™ process, which are collected as particles that were not recovered in the secondary cyclones of the heater within the flexicoker. More specifically, the particles are collected first in the tertiary cyclone as dry flexicoke fines, and the smaller particles that travel past the tertiary cyclone are then recovered in the venturi scrubber as wet flexicoke fines. While at least a portion of such flexicoke fines would typically be considered as waste, the present disclosure provides for the effective utilization of such flexicoke fines during hydraulic fracturing operations.

With respect to the utilization of microproppant coke particles including sieved fluid coke, sieved flexicoke, sieved delayed coke, sieved thermally post-treated coke, sieved pyrolysis coke, and/or sieved coal-derived coke (e.g., sieved blast furnace coke and/or sieved metallurgical coke) as at least a portion of the coke proppant particles described herein, any suitable type(s) of filters, screens, and/or associated machinery may be utilized to separate any suitable type(s) of bulk coke granules into larger particles as well as smaller particles that are suitable for utilization as the microproppant coke particles. Furthermore, with respect to the utilization of microproppant coke particles including ground fluid coke, ground flexicoke, ground delayed coke, ground thermally post-treated coke, ground pyrolysis coke, and/or ground coal-derived coke (e.g., ground blast furnace coke and/or ground metallurgical coke) as at least a portion of the coke proppant particles described herein, any suitable type(s) of grinding/milling technique(s) may be used to produce such microproppant coke particles. For example, in some embodiments, coke granules may be processed using hammer milling techniques, jet milling techniques, ball milling techniques, or the like, where each of these techniques generally involves crushing or pulverizing the coke granules to a suitable size and shape. Moreover, those skilled in the art will appreciate that any number of other grinding, milling, or other processing techniques may be additionally or alternatively used, depending on the details of the particular implementation.

In various embodiments, the microproppant coke particles that may be utilized according to embodiments described herein include a particle size of at most 105 μm (140 mesh) or, in some cases, a particle size of at most 88 μm (170 mesh), but potentially within a range from around 0.0001 μm to 105 μm (e.g., from around 0.0001, 0.001, 0.01, 0.1 μm to 0.5, 1.0, 2.0, 5.0, 8.0 10 μm, to 15, 20, 25, 30, 35, 40, 45 μm, to 50, 53, 55, 60, 63, 65 μm, to 74, 75, 80, 85, 88, 90, 95, 100, 105 μm). Moreover, in various embodiments, such microproppant coke particles have an apparent density that is in a range from around 1.0 g/cm³ to around 2.0 g/cm³ (e.g. 1.0, 1.1, 1.2, 1.3, 1.4, 1.5, 1.6, 1.7, 1.8, 1.9, 2.0 g/cm³), although the exact apparent density of the particles may vary depending on the specific type(s) of coke utilized. By comparison, sand generally has an apparent density of at least around 2.5 g/cm³. Therefore, because the settling rate is proportional to the difference in density between the solid particles and the carrier fluid (as shown in expressions for both Stokes terminal settling velocity and Ferguson & Church settling velocity), such microproppant coke particles have a significantly lower settling rate than sand. As a result, proppant particles formed from microproppant coke particles will perform better than proppant particles formed from sand in terms of transport capacity within hydraulic fractures that are created, reopened, and/or extended during a hydraulic fracturing operation.

Furthermore, with respect to the utilization of microproppant coke particles as at least a portion of the coke proppant particles described herein, such microproppant coke particles provide a number of additional advantages over non-coke proppants. As an example, the microproppant coke particles are small enough to enter regions of secondary and natural fractures that cannot be effectively reached by non-coke proppants. As another example, due to the enhanced transport properties of the microproppant coke particles, such particles are capable of creating larger hydraulic fractures (i.e., by increasing one or more dimensions of such hydraulic fractures, such as the fracture lengths, heights, and/or azimuths) than non-coke proppants. As another example, the utilization of the microproppant coke particles as at least a portion of the coke proppant particles described herein may enable the flow rate of the fracturing fluid to be increased since a portion of the fracturing fluid may be diverted into the secondary hydraulic fractures and/or the natural fractures. As another example, the utilization of the microproppant coke particles as at least a portion of the coke proppant particles described herein may help to control the leak-off of the fracturing fluid into the secondary and natural fractures, thereby increasing the fracturing fluid efficiency and leading to the creation of larger conductive fractures.

Turning to details regarding exemplary characteristics of the fracturing fluid in which the coke proppant particles described herein may be employed, such fracturing fluid may include (in addition to the coke proppant particles) a flowable carrier fluid, one or more optional additives, and (optionally) one or more other types of proppant particles. In various embodiments, the fracturing fluid is formulated at the well site in a mixing process that is conducted concurrently with the pumping of the fracturing fluid into the wellbore during the hydraulic fracturing process. When the fracturing fluid is formulated at the well site, the coke proppant particles may be added in a manner similar to known methods for adding proppant to fracturing fluid.

The carrier fluid according to the present disclosure may be an aqueous carrier fluid that includes water or a nonaqueous carrier fluid that is substantially free of water. Aqueous carrier fluids may include, for example, fresh water, salt water (including seawater), treated water (e.g., treated production water), one or more other forms of aqueous fluid, or any combination thereof. One aqueous carrier fluid class is often referred to as slickwater, and the corresponding fracturing operations are often referred to as slickwater fracturing operations. Nonaqueous carrier fluids may include, for example, oil-based fluids (e.g., hydrocarbon, olefin, mineral oil), alcohol-based fluids (e.g., methanol), or any combination thereof. In various embodiments, the viscosity of the carrier fluid may be altered by foaming or gelling. Foaming may be achieved using, for example, air or other gases (e.g., CO₂, N₂), alone or in combination. Gelling may be achieved using, for example, guar gum (e.g., hydroxypropyl guar), cellulose, or other gelling agents, which may or may not be crosslinked using one or more crosslinkers, such as polyvalent metal ions or borate anions, among other suitable crosslinkers.

In some instances, the carrier fluid used according to embodiments described herein includes one or more aqueous carrier fluid types, particularly in light of the large volumes of fluid that are typically required (e.g., potentially around 60,000 to around 1,000,000 gallons per wellbore (e.g., 60,000, 100,000, 200,000, 300,000, 400,000, 500,000, 600,000, 700,000, 800,000, 900,000 or 1,000,000 gallons per wellbore). The aqueous carrier fluid may or may not be gelled. The utilization of gelled aqueous carrier fluids (either crosslinked or un-crosslinked) may facilitate better proppant particle transport (i.e., reduce settling), as well as provide improved physical and chemical strength to withstand the temperatures, pressures, and shear stresses encountered by the fracturing fluid during a hydraulic fracturing operation. In some instances, the fracturing fluid includes an aqueous carrier fluid, which may or may not be foamed or gelled, and an acid (e.g., HCl) to further stimulate and enlarge pore areas of the matrix of fracture surfaces. It is to be appreciated that the low density of the coke proppant particles described herein may allow a reduction or elimination of the need to foam or gel the carrier fluid. In addition, certain fracturing fluids suitable for use according to embodiments described herein may contain one or more additives. Such additives may include but are not limited to one or more acids, one or more biocides, one or more breakers, one or more corrosion inhibitors, one or more crosslinkers, one or more friction reducers (e.g., polyacrylamides), one or more high-viscosity friction reducers, one or more gels, one or more crosslinked gels, one or more oxygen scavengers, one or more pH control additives, one or more scale inhibitors, one or more surfactants, one or more weighting agents, one or more inert solids, one or more fluid loss control agents, one or more emulsifiers, one or more emulsion thinners, one or more emulsion thickeners, one or more viscosifying agents, one or more foaming agents, one or more stabilizers, one or more chelating agents, one or more mutual solvents, one or more oxidizers, one or more reducers, one or more clay stabilizing agents, or any combination thereof.

With regard to the utilization of coke proppant particles during hydraulic fracturing operations according to aspects and embodiments described herein, the present disclosure provides methods of hydraulic fracturing using a fracturing fluid including coke proppant particles. Such coke proppant particles may be used, alone or in combination with one or more other types of proppant particles, during the hydraulic fracturing operation. That is, the coke proppant particles may form the entirety of a proppant pack or may form an integral part of a proppant pack. Other proppant types that may be utilized with the coke proppant include but are not limited to non-coke proppants (e.g., 100-mesh sand, crushed granite, and/or ceramic beads), lightweight proppants (LWPs), and ultra-LWPs (ULWPs). Moreover, in some embodiments, proppants formed at least in part from fly ash may be utilized with the coke proppant particles described herein. Proppants including other materials are also within the scope of the present disclosure, provided that any such selected proppants are able to maintain their integrity upon removal of hydraulic pressure within an induced hydraulic fracture, such that around 80%, preferably around 90%, and more preferably around 95% or greater of the particle mass of the proppant particles retains integrity when subjected to 5,000 psi of stress, a condition that is also met by the coke proppant particles described herein. That is, both the coke proppant particles and any other type(s) of proppant particles utilized according to embodiments described herein are capable of maintaining mechanical integrity upon fracture closure, as such particles (at least partially) intermingle or otherwise associate to form functional proppant packs for a successful hydraulic fracturing operation.

The methods described herein include the preparation of the fracturing fluid, which is not considered to be particularly limited because the coke proppant particles are capable of transportation in dry form or as part of a wet slurry from a manufacturing site (e.g., a refinery or synthetic fuel plant). Dry and wet forms may be transported via truck or rail, and wet forms may further be transported via pipelines. The transported dry and/or wet forms of the coke proppant particles may be added to the carrier fluid, including the optional additives and/or any other type(s) of proppant particles, at a production site, either directly into a wellbore or by pre-mixing in a hopper or other mixing equipment. For example, in some embodiments, slugs of the dry and/or wet forms of the coke proppant particles are added directly to the fracturing fluid (e.g., as it is introduced into the wellbore). In other embodiments, such as when other type(s) of proppant particles are combined with the coke proppant particles, a portion or all of the fracturing fluid is pre-mixed at the production site, or each proppant type is added directly to the fracturing fluid separately. Any other suitable mixing or adding of the coke proppant particles to produce a desired fracturing fluid composition may also be used, without departing from the scope of the present disclosure.

In certain preferred embodiments, the fracturing fluid used in the methods of this disclosure may comprise coke proppant particles at a concentration of at least 14 kilograms (kg) of coke proppant particles per cubic meter (m³) of the carrier fluid, which can range from, e.g., 14, 15, 16, 17, 18, 19, 20 kg·m⁻³, to 21, 22, 23, 24, 25, 26, 27, 28, 29, 30 kg·m⁻³, to 35, 40, 45, 50, 55, 60, 65, 70 kg·m⁻³, to 80, 90, 95, 96, 100, 150, 160, 180, 200 kg·m⁻³, to 220, 240, 250, 260, 280, 300 kg·m⁻³, to 350, 400, 450, 480 kg·m⁻³, based on the volume of the carrier fluid. A concentration range from 18 to 120 kg·m⁻³ is highly desirable. A preferable concentration range is from 23 to 96 kg·m⁻³. At a total coke particle concentration in the fracturing fluid below 14 kg·m⁻³, the amount of coke particles introduced into the subterranean formation may be too low to function as an effective proppant at a given, reasonable volume of carrier fluid; or alternatively, if a reasonable amount of coke particles were to be introduced into the subterranean formation, an infeasibly large volume of the carrier fluid would have to be injected. Either case would be highly undesirable. At a coke particle concentration in the fracturing fluid at above 480 kg·m⁻³, the cost of the coke particles can be too high to justify additional benefit of the higher amount, if any at all. At high loading of the coke proppant particles, the fracturing fluid may become too thick to be effectively pumped.

The methods of hydraulic fracturing suitable for use in one or more embodiments described herein involve pumping the fracturing fluid including the coke proppant particles at a high pump rate into a subterranean formation to form hydraulic fractures in the subterranean formation. In various embodiments, this process is conducted one stage at a time along a wellbore. Specifically, the stage of interest is hydraulically isolated from any other stages that have been previously hydraulically fractured and propped. In some embodiments, the stage of interest includes perforation clusters within the production casing string of the wellbore, which enable the fracturing fluid to flow out of the wellbore and into the subterranean formation. In some embodiments, the pump rate of the fracturing fluid during the hydraulic fracturing operation is at least around 20 barrels per minute (bbl/min) (0.05 cubic meters per second (m³/s)), preferably at least around 30 bbl/min (0.08 m³/s), and more preferably at least 50 bbl/min (0.14 m³/s) and at most 1000 bbl/min (2.73 m³/s) at one or more time durations during the hydraulic fracturing operation (e.g., the rate may be constant, steadily increased, or pulsed). Exemplary pump rates include 20, 30, 50, 100, 150, 100, 250, 300, 350, 400, 450, 500, 550, 600, 650, 700, 750, 800, 850, 900, 950 or 1000 bbl/min, to name a few non-limiting examples). These high rates may, in some embodiments, be utilized after around 10% of the entire volume of fracturing fluid to be pumped into the subterranean formation has already been injected. That is, at the early periods of the hydraulic fracturing operation, the pump rate may be lower and as hydraulic fractures begin to form, the pump rate may be increased. Generally, the average pump rate of the fracturing fluid throughout the hydraulic fracturing operation may be around 10 bbl/min (0.03 m³/s), preferably around 15 bbl/min (0.04 m³/s), and more preferably at least 25 bbl/min (0.07 m³/s) and at most 250 bbl/min (0.68 m³/s). Exemplary average pump rates include 10, 15, 20, 25, 30, 35, 40, 45, 50, 55, 60, 65, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245 or 250 bbl/min, to name a few non-limiting examples). Typically, the pump rate of the fracturing fluid during the hydraulic fracturing operation for more than 30% of the time required to complete the hydraulic fracturing with respect to a particular stage may be in the range of around 20 bbl/min (0.05 m³/s) to around 150 bbl/min (0.41 m³/s), or around 40 bbl/min (0.11 m³/s) to around 120 bbl/min (0.33 m³/s), or around 40 bbl/min (0.11 m³/s) to around 100 bbl/min (0.27 m³/s). Exemplary pump rates include 20, 25, 30, 35, 40, 45, 50, 55, 60, 65, 70, 75, 80, 85, 90, 95 or 100 bbl/min, to name a few non-limiting examples).

In various embodiments, the methods of hydraulic fracturing described herein may be performed such that the concentration of the coke proppant particles (and any other type(s) of proppant particles) within the injected fracturing fluid is altered on-the-fly or in real-time while the hydraulic fracturing operation is being performed, such that the hydraulic pressure is maintained in the subterranean formation and the hydraulic fractures. For example, in some embodiments, the initially-injected fracturing fluid is injected at a low pump rate and includes around 1 weight percent (wt %) proppant particles (i.e., including the coke proppant particles and any other type(s) of proppant particles) based on the total weight of the fracturing fluid (i.e., including the carrier fluid, the coke proppant particles, any other type(s) of proppant particles, and any additives). As hydraulic fractures begin to form and grow, the pump rate may be increased, and the concentration of the proppant particles may be increased in a stepwise fashion (with or without a corresponding stepwise increase in pump rate), with a maximum concentration of total proppant particles potentially reaching around 2.5 wt % to around 20 wt %, for example, based on the total weight of the fracturing fluid. For example, the maximum concentration of total proppant particles may reach at least 2.5 wt %, preferably at least 8 wt %, and more preferably at least 16 wt %. In some embodiments, all of the proppant particles are coke particles. In other embodiments, at one or more time periods during the hydraulic fracturing operation, at least around 2 wt % to around 100 wt % of any proppant particles suspended within the fracturing fluid are coke particles, such as at least around 2 wt %, preferably at least around 15 wt %, more preferably at least around 25 wt %, and up to 100 wt % in some cases.

In various embodiments, the coke proppant particles are introduced into the subterranean formation during the pad phase of the hydraulic fracturing operation to allow the coke proppant particles to travel with the fracturing fluid into the tips (or at least within proximity to the tips) of the formed hydraulic fractures. In such embodiments, the coke proppant particles may also be introduced into the subterranean formation during the later phases of the hydraulic fracturing operation such that the later-introduced slurry of fracturing fluid and coke proppant particles continue to displace the earlier-introduced slurry of fracturing fluid and coke proppant particles further away from the wellbore. Moreover, in some embodiments, the coke proppant particles are introduced into the subterranean formation throughout the hydraulic fracturing operation, either continuously or intermittently. In such embodiments, the ratio of coke proppant particles to other type(s) of proppant particles, if any, introduced into the subterranean formation may be maintained at a steady (or substantially steady) value, or the ratio may be modified as the hydraulic fracturing operation progresses.

The hydraulic fracturing methods described herein may be performed in drilled hydrocarbon-producing wellbores including vertical, deviated, highly deviated, and/or lateral sections. Moreover, for embodiments in which the hydraulic fracturing operation is performed with respect to a hydrocarbon well including one or more long lateral sections as described herein, such long lateral section(s) of the wellbore extend for at least 1,000 ft in length, but in some cases for at least 10,000 ft in length or at least 15,000 ft in length, but potentially up to around 50,000 ft in length, depending on the details of the particular implementation. Exemplary lateral section lengths include 1,000, 1,500, 2,000, 2,500, 3,000, 3,500, 4,000, 4,500, 5,000, 5,500, 6,000, 6,500, 7,000, 7,500, 8,000, 8,500, 9,000, 9,500, 10,000, 15,000, 20,000, 25,000, 30,000, 35,000, 40,000, 45,000 or 50,000 ft, to name a few non-limiting examples).

Such wellbores may be drilled into various types of unconventional subterranean formations, including but not limited to tight sandstone formations, tight carbonate formations, shale gas formations, coal bed methane formations, and/or tight oil formations. As described herein, such wellbores are typically completed using casing strings that are cemented into the subterranean formation. To contact the subterranean formation, a number of perforation clusters are typically created through the production casing string, in which case the wellbore may be referred to as a plug and perforated (“plug-and-perf”) cased-hole completion. Alternative completion techniques may be used without departing from the scope of the present disclosure, but in each completion technique, a finite length of the wellbore is exposed for hydraulic fracturing and injection of the fracturing fluid. This finite section is referred to herein as a “stage.” In plug-and-perf completions, the stage length may be based on a distance over which the tubular and cement has been perforated, and may be in excess of around 25 ft, but more typically in excess of around 100 ft. Exemplary stage lengths include 25, 30, 35, 40, 45, 50, 55, 60, 65, 70, 75, 80, 85, 90, 95, 100 ft or more, to name a few non-limiting examples. Moreover, for embodiments in which the hydraulic fracturing operation is performed with respect to a hydrocarbon well including longer stages as described herein, the stage length is at least 200 ft but, in some cases, at least 300 ft, at least 400 ft, or at least 1,000 ft, but at most the length of the wellbore, depending on the details of the particular implementation. Taking a wellbore including a 10,000 ft lateral section as an example (e.g., as measured from heel to toe), according to conventional techniques utilizing non-coke proppant, such wellbore may be divided into 100 stages, each with a stage length of 100 ft. However, according to aspects and embodiments described herein, the utilization of coke proppant particles may enable such wellbore to be efficiently divided into only 50 stages, each with a stage length of 200 ft or, alternatively, only 25 stages, each with a stage length of 400 ft, to name a few non-limiting examples, while still providing for the effective and relatively uniform distribution of the fracturing fluid among the perforation clusters within each stage. Furthermore, according to aspects and embodiments described herein, the utilization of coke proppant particles may enable the number of perforation clusters per stage to be effectively increased, with or without a corresponding increase in stage length. For example, the utilization of coke proppant particles may enable the cluster count to be increased to at least 6 perforation clusters per stage, but in some cases at least 8 perforation clusters per stage and at most 1,000 perforation clusters per stage, (e.g., 6, 8, 10, 12, 15, 20, 30, 40, 50, 60, 70, 80, 90, 100, 150, 200, 250, 300, 350, 400, 450, 500, 550, 600, 650, 700, 750, 800, 850, 900, 950 or 1,00 perforation clusters per stage, to name a few non-limiting examples) while still providing for the effective and relatively uniform distribution of the fracturing fluid among the perforation clusters within each stage. In some embodiments, this is accomplished, at least in part, by increasing the stage length. Additionally or alternatively, in some embodiments, this is accomplished by decreasing the cluster spacing (where the term “cluster spacing” refers to the distance between perforation clusters). For example, while the cluster spacing is often around 25 ft, it may be reduced to as little as 7 ft or even 5 ft to accommodate a larger number of perforation clusters in each stage. As a non-limiting example, with a stage length of around 200 ft and a cluster spacing of around 7 ft, each stage may include over 25 perforation clusters.

During the plug-and-perf process, the stage of interest may be isolated using one or more diversions materials such that the pressurized fracturing fluid flows through the perforation clusters within the particular stage and into the subterranean formation to generate one or more hydraulic fractures in only the stage area. Such diversion materials may include but are not limited to one or more types of plugs (e.g., bridge plugs, packers, baffle/plug combinations, or the like), one or more types of particulate diverters (e.g., sand, ceramic material, salt, wax, resin, and/or other compounds), one or more types of perforation plugging devices, one or more types of ball-and-seat devices (e.g., ball sealers, with or without retaining devices), one or more types of chemical diverters (e.g., liquids and/or gels), and/or one or more types of dart-and-sleeve devices (e.g., any type of sleeve device in which a ball or dart is dropped from the surface, contacting and opening a particular sleeve, which permits injections into a new stage, while simultaneously blocking flow to the stages below). Moreover, in some embodiments, at least a portion of such diversion materials are provided in dissolvable, biodegradable, or self-destructible form, such that the diversion materials are designed to dissolve, degrade, or self-destruct, respectively, and then flow out of the wellbore, potentially without performing a wellbore cleanout procedure.

For each linear foot of the stage, at least around 6 barrels (24 cubic feet (ft³)), preferably around 24 barrels (135 ft³), and more preferably at least 60 barrels (335 ft³) and at most 6,000 barrels (33,500 ft³) (e.g., 6, 8, 10, 12, 14, 16, 18, 20, 22, 24, 50, 75, 100, 500, 1,000, 1,500, 2,000, 2,500, 3,000, 3,500, 4,000, 4,500, 5,000, 5,500, or 6,000 barrels, to name a few non-limiting examples) of fracturing fluid may be injected to grow the hydraulic fractures. In certain embodiments, for each linear foot of the stage, at least around 0.3 barrels (1.6 ft³), preferably around 1.1 barrels (6.4 ft³), and more preferably at least 2.8 barrels (16 ft³) and at most 285 barrels (1600 ft³) (e.g., 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 5, 10, 20, 30, 40, 50, 60, 70, 75, 80, 85, 90, 95, 100, 105, 110, 115, 120, 125, 130, 135, 140, 145, 150, 155, 160, 165, 170, 175, 180, 185, 190, 195, 200, 205, 210, 215, 220, 225, 230, 235, 240, 245, 250, 255, 260, 265, 270, 275, 280 or 285 barrels, to name a few non-limiting examples) of proppant particles (i.e., including the coke proppant particles and any other type(s) of proppant particles) may be injected to prop the hydraulic fractures.

According to aspects and embodiments described herein, such hydraulic fracturing operations are performed for hydrocarbon wells including long lateral sections, hydrocarbon wells including long stages, hydrocarbons wells including high cluster counts, and/or any combination thereof. The following provides a discussion of exemplary embodiments pertaining to the hydraulic fracturing of subterranean formations via hydrocarbon wells including long lateral sections of at least 1,000 ft in length, as well as a discussion of exemplary embodiments pertaining to the hydraulic fracturing of subterranean formations via hydrocarbon wells including long stage lengths of at least 200 ft and/or high cluster counts of at least 6 perforation clusters per stage. However, it should be understood that this is for ease of discussion only, as such exemplary embodiments can be separated or combined in any suitable manner for hydrocarbon wells that include any combination of long lateral sections, long stages, and/or high cluster counts.

Turning first to exemplary embodiments of hydraulic fracturing methods for a hydrocarbon well including one or more relatively long lateral sections of at least 1,000 ft in length, the utilization of the coke proppant particles described herein for such hydraulic fracturing operation provides for the improved transport of proppant into hydraulic fractures corresponding to stages located closer to the toe of the lateral section. In general, as the length of a wellbore increases, the friction within the wellbore increases, causing a relatively large pressure drop within the wellbore. Moreover, since pressures are limited at the surface, relatively low pump rates are typically used when treating the stages located closer to the toe of the lateral section. As the lateral section within the wellbore becomes very lengthy (i.e., at least 1,000 ft in length but in some cases at least 10,000 ft in length or even at least 15,000 ft in length), such frictional pressure drop within the wellbore becomes particularly pronounced. However, the utilization of the coke proppant particles described herein as at least a portion of the proppant within the fracturing fluid enables the stages located closer to the toe of the lateral section to still be effectively treated during the hydraulic fracturing operation. In particular, due at least in part to the relatively low densities, relatively small particle sizes, and relatively low settling velocities of the coke proppant particles described herein, a relatively large percentage of such coke proppant particles remain suspended within the fracturing fluid as it flows through the long lateral section, despite the large frictional pressure drop that is experienced along such long lateral section. This enables the coke proppant particles to more uniformly travel through the perforation clusters and into the hydraulic fractures corresponding to the stages located closer to the toe of the lateral section, thus increasing the SRV in the subterranean formation and leading to increased production performance for the corresponding hydrocarbon well. Furthermore, this can be achieved by pumping the fracturing fluid at a relatively low pump rate, thus reducing the likelihood of cluster-level screen-out. In addition, the perforations will experience minimal erosion during such hydraulic fracturing operation since the coke proppant particles described herein are less erosive than non-coke proppants.

Furthermore, the utilization of the coke proppant particles described herein for such hydraulic fracturing operation provides for the improved clean out of such long lateral section, potentially without performing a cleanout procedure. In particular, as described herein, it can be challenging to fully clean out the wellbore of such a hydrocarbon well due to the extensive length of the lateral section. In some cases, the lateral section is so lengthy that the cleanout bottomhole assembly (BHA) is unable to reach the stages located closer to the toe of the lateral section. As a result, dissolvable, biodegradable, or self-destructible diversion materials (e.g., dissolvable plugs) are often utilized within the wellbore with the expectation that such diversion materials will disappear without performing a cleanout procedure. However, even in such cases, cleanout is often still performed since sand bridges often form around the diversion materials, thus blocking flow from downstream of the diversion materials and preventing the diversion materials from effectively flowing out of the wellbore (e.g., after such materials have dissolved, biodegraded, or self-destructed).

The utilization of the coke proppant particles described herein as at least a portion of the proppant within the fracturing fluid during the hydraulic fracturing operation may substantially prevent or mitigate this issue with sand bridging and, in some cases, prevent the need for a cleanout procedure. Specifically, the coke proppant particles are less likely to settle in the dead space between the last perforation cluster in each stage and the dissolvable, biodegradable, or self-destructible diversion material (e.g., dissolvable plug) installed immediately below such stage. As a result, when the diversion material dissolves, biodegrades, or self-destructs, there is less likely to be a bridge of particle that prevents the diversion material from flowing out of the wellbore. Moreover, even if the coke particles do form some type of particle bridge around the diversion material, such particle bridge will more easily dislodge than a typical sand bridge. Therefore, the diversion material will likely still flow out of the wellbore along with the dislodged particles.

Moreover, the utilization of the coke proppant particles described herein as at least a portion of the proppant within the fracturing fluid during the hydraulic fracturing operation may substantially prevent or mitigate issues with cluster-level screen-out, in which case proppant piles up on the inside of the production casing string and prevents the transport of the fracturing fluid (and the corresponding proppant) into the perforation clusters. Such cluster-level screen-out issues are particularly common for hydraulic fracturing operations that utilize non-coke proppants (e.g., sand) since such non-coke proppants are prone to settle within the production casing string prior to flowing through the perforation clusters, as well as to flow back into the production casing string when the hydrocarbon well is brought on production. However, as described herein, the relatively low densities, relatively small particle sizes, and relatively low settling velocities of the coke proppant particles described herein enable such particles to transport more efficiently through the perforation clusters and into the hydraulic fractures, reducing the likelihood that such particles will contribute to cluster-level screen-out issues. In addition, such coke proppant particles are less likely than non-coke proppants to flow back into the production casing string when the hydrocarbon well is brought on production, further reducing the likelihood that such particles will contribute to cluster-level screen-out issues.

Furthermore, as described herein, limited-entry and extreme-limited-entry methods are sometimes utilized to improve the uniformity of fracturing fluid distribution throughout long lateral sections that include relatively large numbers of stages. Limited-entry methods are designed to provide pressure drops of at least 500 psi across the perforations, while extreme-limited-entry methods are designed to provide pressure drops of at least 2,000 psi across the perforations. This may be accomplished in various ways, including, for example, by varying the number of perforations within the perforation clusters and/or reducing the size of the perforations to control the flow of the fracturing fluid. However, such limited-entry and extreme-limited-entry methods have had limited success in increasing the treatment uniformity for such long lateral sections. Specifically, because the erosive properties of non-coke proppants are particularly pronounced at such large pressure differentials, wellbore friction that is caused at least in part by the erosion of the production casing string along the lateral section may compromise the ability of the fracturing fluid to uniformly flow across the relatively long lateral section and into stages that are located closer to the toe of the lateral section. As a result, such wellbore friction may effectively negate the potential advantages of such limited-entry and extreme-limited-entry methods. However, the utilization of the coke proppant particles described herein as at least a portion of the fracturing fluid during the hydraulic fracturing operation may substantially prevent or mitigate such issues with limited-entry and extreme-limited-entry methods. Specifically, as described herein, coke particles, such as, in particular, petroleum coke particles are expected to be less erosive than non-coke proppant particles, such as sand. As a result, the utilization of coke proppant particles enables the wellbore friction to be reduced and/or controlled such that erosion of the production casing string is minimized, thus allowing the fracturing fluid to flow more efficiently into the stages that are located closer to the toe of the lateral section.

Turning now to exemplary embodiments of hydraulic fracturing methods for hydrocarbon wells including relatively long stage lengths of at least 200 ft and/or relatively high cluster counts of at least 6 perforation clusters per stage, the utilization of the coke proppant particles described herein for such hydraulic fracturing operation provides for the improved transport of proppant through the perforation clusters located further downstream within each stage (i.e., further towards the toe of the wellbore). In general, such long stages and/or high cluster counts are desirable because the hydraulic fracturing of such stages can be completed in substantially less time and with lower overall cost, typically with fewer wireline runs and less potential for downhole tools to become stuck in the wellbore. However, because the flow rate of the fracturing fluid into each perforation cluster decreases as the stage length and/or the number of perforation clusters increases, it is challenging to effectively treat stages that are 200 ft or more in length and/or stages with 6 or more perforation clusters. Specifically, due to the relatively low flow rate of the fracturing fluid through the perforation clusters, the corresponding hydraulic fractures tend to grow more laterally than vertically, thereby limiting the resulting SRV in the subterranean formation. Therefore, according to aspects and embodiments described herein, coke proppant particles are utilized as at least a portion of the proppant within the fracturing fluid during the hydraulic fracturing operation to substantially prevent or mitigate this issue. In particular, as described herein, the relatively low densities, relatively small particle sizes, and relatively low settling velocities of the coke proppant particles enable such particles to stay suspended within the fracturing fluid even at relatively low flow rates and, therefore, to transport more efficiently through the perforation clusters that are located further downstream within each stage.

Furthermore, as described herein, limited-entry and extreme-limited-entry methods are sometimes utilized to improve the uniformity of fracturing fluid distribution throughout long stages and/or stages including relatively large numbers of perforation clusters. However, such limited-entry and extreme-limited-entry methods have had limited success in increasing the treatment uniformity for such long stages and/or high cluster counts. Specifically, because the erosive properties of non-coke proppants are particularly pronounced at such large pressure differentials, the erosion of the perforation clusters located further upstream within each stage (i.e., further towards the heel of the wellbore) typically interferes with the flow of the fracturing fluid through the perforation clusters located further downstream within each stage, thereby negating the potential advantages of such limited-entry and extreme-limited-entry methods. However, the utilization of the coke proppant particles described herein as at least a portion of the fracturing fluid during the hydraulic fracturing operation may substantially prevent or mitigate such issues with limited-entry and extreme-limited-entry methods. Specifically, as described herein, coke particles, such as, in particular, petroleum coke particles, are less erosive than non-coke proppant particles, such as sand. As a result, the utilization of coke proppant particles enables the perforation friction to be reduced and/or controlled such that erosion of the perforation clusters that are located further upstream within each stage is minimized, thus allowing the fracturing fluid to flow more efficiently through the perforation clusters located further downstream within each stage.

As described herein, during the treatment of a particular stage of a wellbore, the flow rate of the fracturing fluid is gradually reduced as a portion of the fracturing fluid flows through each perforation cluster. For a particularly long stage and/or a stage including a relatively large number of perforation clusters, such reduction in flow rate may compromise the ability of the fracturing fluid to effectively treat the perforation clusters that are located further downstream within the stage. However, the utilization of the coke proppant particles described herein as at least a portion of the proppant within the fracturing fluid during the hydraulic fracturing operation may substantially prevent or mitigate this issue. Specifically, because the coke proppant particles have much lower settling velocities than those of sand, a relatively large percentage of the coke proppant particles remain suspended within the fracturing fluid as it flows through the stage and effectively transports through the perforation clusters that are located further downstream within the stage, despite the reduction in flow rate.

In addition, the advantages described above with respect to cluster-level screen-out issues within wellbores including long lateral sections equally apply to wellbores including long stages and/or high cluster counts. In particular, the utilization of coke proppant particles reduces the likelihood of cluster-level screen-out as compared to the utilization of non-coke proppant particles, which is especially beneficial for relatively long stages and/or stages including relatively large numbers of perforation clusters.

Turning to details of an exemplary hydraulic fracturing method according to the present disclosure, FIG. 6 is a process flow diagram of an exemplary method 600 for hydraulically fracturing a subterranean formation via a hydrocarbon well including a lateral section of at least 1,000 ft in length, a stage length of at least 200 ft, and/or a cluster count of at least 6 perforation clusters per stage using coke proppant particles in accordance with the present disclosure. The exemplary method 600 begins at block 602, at which a subterranean formation is hydraulically fractured via a wellbore including a lateral section of at least 1,000 ft in length (e.g., in some cases, at least 10.00 ft in length or even at least 15,000 ft in length), a stage length of at least 200 ft (e.g., in some cases, at least 400 ft or even at least 1,000 ft), and/or a cluster count of at least 6 perforation clusters per stage (e.g., in some cases, at least 10 perforations clusters per stage or even at least 25 perforation clusters per stage). Specifically, the subterranean formation is hydraulically fractured via the introduction of a fracturing fluid including a carrier fluid and coke proppant particles into the subterranean formation via the wellbore. In various embodiments, this is performed in accordance with one or more limited entry methods and/or one or more extreme limited entry methods, as described herein. Moreover, in various embodiments, one or more diversion materials are used to direct the flow of the fracturing fluid within the wellbore. Such diversion material(s) may include but are not limited to one or more plugs, one or more particulate diverters, one or more perforation plugging devices, one or more ball-and-seat devices, one or more chemical diverters, and/or one or more dart-and-sleeve devices. Moreover, in some embodiments, the diversion material(s) (or at least a portion thereof) are dissolvable, biodegradable, or self-destructible.

In some embodiments, the coke proppant particles include fluid coke, flexicoke, delayed coke, thermally post-treated coke, pyrolysis coke, and/or coal-derived coke (e.g., blast furnace coke and/or metallurgical coke). In some embodiments, the coke proppant particles include microproppant coke particles. In such embodiments, the microproppant coke particles may include wet flexicoke fines and/or dry flexicoke fines. Additionally or alternatively, in such embodiments, the microproppant coke particles may include sieved fluid coke, sieved flexicoke, sieved delayed coke, sieved thermally post-treated coke, sieved pyrolysis coke, and/or sieved coal-derived coke (e.g., sieved blast furnace coke and/or sieved metallurgical coke). Additionally or alternatively, in such embodiments, the microproppant coke particles may include ground fluid coke, ground flexicoke, ground delayed coke, ground thermally post-treated coke, ground pyrolysis coke, and/or ground coal-derived coke (e.g., ground blast furnace coke and/or ground metallurgical coke).

In various embodiments, the fracturing fluid is introduced into the subterranean formation via the wellbore for each of a number of stages of the hydrocarbon well. For each stage, the fracturing fluid including the carrier fluid and the coke proppant particles may be introduced into the subterranean formation during at least a portion of the pad phase of the hydraulic fracturing operation, prior to the introduction of a second fracturing fluid including the carrier fluid and second proppant particles that do not include coke into the subterranean formation. In some such embodiments, the second proppant particles including sand, LWP, ULWP, and/or fly ash. Alternatively, for each stage, the fracturing fluid itself may include the second proppant particles (in addition to the coke proppant particles), and the fracturing fluid including the carrier fluid, the coke proppant particles, and the second proppant particles may be introduced into the subterranean formation during at least a portion of the pad phase of the hydraulic fracturing operation, as well as during at least a portion of the remainder of the hydraulic fracturing operation.

In some embodiments, the carrier fluid is an aqueous carrier fluid including water. In other embodiments, the carrier fluid is a nonaqueous carrier fluid that is substantially free of water. Moreover, in some embodiments, the fracturing fluid also includes one or more additives, including but not limited to one or more acids, one or more biocides, one or more breakers, one or more corrosion inhibitors, one or more crosslinkers, one or more friction reducers (e.g., polyacrylamides), one or more high-viscosity friction reducers, one or more gels, one or more crosslinked gels, one or more oxygen scavengers, one or more pH control additives, one or more scale inhibitors, one or more surfactants, one or more weighting agents, one or more inert solids, one or more fluid loss control agents, one or more emulsifiers, one or more emulsion thinners, one or more emulsion thickeners, one or more viscosifying agents, one or more foaming agents, one or more stabilizers, one or more chelating agents, one or more mutual solvents, one or more oxidizers, one or more reducers, and/or one or more clay stabilizing agents.

Furthermore, at optional block 604, hydrocarbon fluids are produced from the subterranean formation via the wellbore subsequent to the hydraulic fracturing of the subterranean formation. According to aspects and embodiments described herein, the utilization of the coke proppant particles as at least a portion of the proppant within the fracturing fluid introduced into the subterranean formation at block 602 increases the overall SRV in the subterranean formation, leading to enhanced production performance for the hydrocarbon well.

Those skilled in the art will appreciate that the exemplary method 600 of FIG. 6 is susceptible to modification without altering the technical effect provided by the present disclosure. For example, in some embodiments, one or more blocks may be omitted from the method 600, and/or one or more blocks may be added to the method 600. In practice, the exact manner in which the method 600 is implemented will depend at least in part on the details of the specific implementation.

This disclosure can include one or more of the following non-limiting aspects and/or embodiments:

A1. A method, comprising hydraulically fracturing a subterranean formation via a wellbore comprising a lateral section of at least 1,000 feet in length, a stage length of at least 200 feet, and/or a cluster count of at least 6 perforation clusters per stage by introducing a fracturing fluid comprising a carrier fluid and coke proppant particles into the subterranean formation via the wellbore.

A2. The method of A1, wherein the coke proppant particles are present in the fracturing fluid at a concentration from 14 kilograms per cubic meter to 480 kilograms per cubic meter, based on the volume of the carrier fluid.

A3. The method of A1, wherein the coke proppant particles are present in the fracturing fluid at a concentration from 18 kilograms per cubic meter to 120 kilograms per cubic meter, based on the volume of the carrier fluid.

A4. The method of A1, wherein the coke proppant particles are present in the fracturing fluid at a concentration from 23 kilograms per cubic meter to 96 kilograms per cubic meter, based on the volume of the carrier.

A5. The method of A1, comprising producing hydrocarbon fluids from the subterranean formation via the wellbore subsequent to the hydraulic fracturing of the subterranean formation.

A6. The method of A1 or A5, comprising introducing the fracturing fluid comprising the carrier fluid and the coke proppant particles into the subterranean formation via the wellbore in accordance with at least one of a limited entry method and an extreme limited entry method.

A7. The method of any of A1 to A6, wherein the lateral section is at least 10,000 feet in length.

A8. The method of any of A1 to A7, wherein the stage length is at least 400 feet, and wherein the cluster count is at least 10 perforation clusters per stage.

A9. The method of any of A1 to A8, comprising, during the introduction of the fracturing fluid comprising the carrier fluid and the coke proppant particles into the subterranean formation via the wellbore, utilizing at least one diversion material to direct a flow of the fracturing fluid within the wellbore.

A10. The method of A9, wherein the at least one diversion material comprises at least one of a plug, a particulate diverter, a perforation plugging device, a ball-and-seat device, a chemical diverter, and a dart-and-sleeve device.

A11. The method of any of A1 to A10, wherein the coke proppant particles comprise at least one of: fluid coke; flexicoke; delayed coke; thermally post-treated coke; pyrolysis coke; and coal-derived coke.

A12. The method of any of A1 to A11, wherein the coke proppant particles comprise microproppant coke particles.

A13. The method of any of A1 to A12, comprising introducing the fracturing fluid comprising the carrier fluid and the coke proppant particles into the subterranean formation via the wellbore for each of at least a portion of a plurality of stages of the hydrocarbon well.

A14. The method of A13, comprising, for each of the at least the portion of the plurality of stages, introducing the fracturing fluid comprising the carrier fluid and the coke proppant particles into the subterranean formation during at least a portion of a pad phase of a hydraulic fracturing operation, prior to an introduction of a second fracturing fluid comprising the carrier fluid and second proppant particles that do not comprise coke into the subterranean formation.

A15. The method of A14, wherein the second proppant particles comprise at least one of sand, LWP, ULWP, and fly ash.

A16. The method of A13, wherein the fracturing fluid further comprises second proppant particles that do not comprise coke, and wherein the method comprises, for each of the at least the portion of the plurality of stages, introducing the fracturing fluid comprising the carrier fluid, the coke proppant particles, and the second proppant particles into the subterranean formation during at least a portion of a pad phase of a hydraulic fracturing operation, as well as during at least a portion of a remainder of the hydraulic fracturing operation.

A17. The method of A16, wherein the second proppant particles comprise at least one of sand, LWP, ULWP, and fly ash.

A18. The method of any of A1 to A17, wherein the carrier fluid comprises water.

A19. The method of any of A1 to A17, wherein the carrier fluid is substantially free of water.

A20. The method of any of A1 to A19, wherein the fracturing fluid further comprises at least one of an acid, a biocide, a breaker, a corrosion inhibitor, a crosslinker, a friction reducer, a high-viscosity friction reducer, a gel, a crosslinked gel, an oxygen scavenger, a pH control additive, a scale inhibitor, a surfactant, a weighting agent, an inert solid, a fluid loss control agent, an emulsifier, an emulsion thinner, an emulsion thickener, a viscosifying agent, a foaming agent, a stabilizer, a chelating agent, a mutual solvent, an oxidizer, a reducer, and a clay stabilizing agent.

B1. A hydrocarbon well, comprising: a wellbore that extends within a subterranean formation, wherein the wellbore comprises a lateral section of at least 1,000 feet in length as measured from a heel of the wellbore to a toe of the wellbore; a production casing string that extends within the lateral section of the wellbore; perforation clusters formed within the production casing string; hydraulic fractures formed in the subterranean formation proximate to the perforation clusters; and coke proppant particles positioned within at least a portion of the hydraulic fractures, wherein the at least the portion of the hydraulic fractures comprises one of the hydraulic fractures that is formed in the subterranean formation proximate to one of the perforation clusters that is closest to the toe the wellbore.

B2. The hydrocarbon well of B1, wherein the lateral section is at least 10,000 feet in length.

B3. The hydrocarbon well of B1 or B2, wherein the coke proppant particles comprise at least one of: fluid coke; flexicoke; delayed coke; thermally post-treated coke; pyrolysis coke; and coal-derived coke.

B4. The hydrocarbon well of any of B1 to B3, wherein the hydrocarbon well further comprises second proppant particles that do not comprise coke within at least a portion of the hydraulic fractures.

C1. A hydrocarbon well, comprising: a wellbore that extends within a subterranean formation; a production casing string that extends within at least a portion of the wellbore; a plurality of stages within the production casing string, wherein each of the plurality of stages comprises a stage length of at least 200 feet; perforation clusters formed within each of the plurality of stages; hydraulic fractures formed in the subterranean formation proximate to the perforation clusters; and coke proppant particles positioned within at least a portion of the hydraulic fractures, wherein the at least the portion of the hydraulic fractures comprises one of the hydraulic fractures that is formed in the subterranean formation proximate to one of the perforation clusters that is furthest downstream within a corresponding stage.

C2. The hydrocarbon well of C1, wherein the stage length is at least 400 feet.

D1. A hydrocarbon well, comprising: a wellbore that extends within a subterranean formation; a production casing string that extends within at least a portion of the wellbore; a plurality of stages within the production casing string; at least 6 perforation clusters formed within each of the plurality of stages; hydraulic fractures formed in the subterranean formation proximate to the perforation clusters; and coke proppant particles positioned within at least a portion of the hydraulic fractures, wherein the at least the portion of the hydraulic fractures comprises one of the hydraulic fractures that is formed in the subterranean formation proximate to one of the perforation clusters that is furthest downstream within a corresponding stage.

D2. The hydrocarbon well of D1, comprising at least 10 perforation clusters formed within each of the plurality of stages.

While the embodiments described herein are well-calculated to achieve the advantages set forth, it will be appreciated that such embodiments are susceptible to modification, variation, and change without departing from the spirit thereof. In other words, the particular embodiments described herein are illustrative only, as the teachings of the present disclosure may be modified and practiced in different but equivalent manners apparent to those skilled in the art having the benefit of the teachings herein. Moreover, the systems and methods illustratively disclosed herein may suitably be practiced in the absence of any element that is not specifically disclosed herein and/or any optional element disclosed herein. While compositions and methods are described in terms of “comprising” or “including” various components or steps, the compositions and methods can also “consist essentially of” or “consist of” the various components and steps. Indeed, the present disclosure includes all alternatives, modifications, and equivalents falling within the true spirit and scope of the appended claims.

What is claimed is:

1. A method, comprising hydraulically fracturing a subterranean formation via a wellbore comprising a lateral section of at least 1,000 feet in length, a stage length of at least 200 feet, and/or a cluster count of at least 6 perforation clusters per stage by introducing a fracturing fluid comprising a carrier fluid and coke proppant particles into the subterranean formation via the wellbore.

2. The method of claim 1, wherein the coke proppant particles are present in the fracturing fluid at a concentration from 14 kilograms per cubic meter to 480 kilograms per cubic meter, based on the volume of the carrier fluid.

3. The method of claim 1, wherein the coke proppant particles are present in the fracturing fluid at a concentration from 18 kilograms per cubic meter to 120 kilograms per cubic meter, based on the volume of the carrier fluid.

4. The method of claim 1, wherein the coke proppant particles are present in the fracturing fluid at a concentration from 23 kilograms per cubic meter to 96 kilograms per cubic meter, based on the volume of the carrier.

5. The method of claim 1, comprising producing hydrocarbon fluids from the subterranean formation via the wellbore subsequent to the hydraulic fracturing of the subterranean formation.

6. The method of claim 1, comprising introducing the fracturing fluid comprising the carrier fluid and the coke proppant particles into the subterranean formation via the wellbore in accordance with at least one of a limited entry method and an extreme limited entry method.

7. The method of claim 1, wherein the lateral section is at least 10,000 feet in length.

8. The method of claim 1, wherein the stage length is at least 400 feet, and wherein the cluster count is at least 10 perforation clusters per stage.

9. The method of claim 1, comprising, during the introduction of the fracturing fluid comprising the carrier fluid and the coke proppant particles into the subterranean formation via the wellbore, utilizing at least one diversion material to direct a flow of the fracturing fluid within the wellbore.

10. The method of claim 9, wherein the at least one diversion material comprises at least one of a plug, a particulate diverter, a perforation plugging device, a ball-and-seat device, a chemical diverter, and a dart-and-sleeve device.

11. The method of claim 1, wherein the coke proppant particles comprise at least one of:
fluid coke;
flexicoke;
delayed coke;
thermally post-treated coke;
pyrolysis coke; and
coal-derived coke.

12. The method of claim 1, wherein the coke proppant particles comprise microproppant coke particles.

13. The method of claim 1, comprising introducing the fracturing fluid comprising the carrier fluid and the coke proppant particles into the subterranean formation via the wellbore for each of at least a portion of a plurality of stages of the hydrocarbon well.

14. The method of claim 13, comprising, for each of the at least the portion of the plurality of stages, introducing the fracturing fluid comprising the carrier fluid and the coke proppant particles into the subterranean formation during at least a portion of a pad phase of a hydraulic fracturing operation, prior to an introduction of a second fracturing fluid comprising the carrier fluid and second proppant particles that do not comprise coke into the subterranean formation.

15. The method of claim 14, wherein the second proppant particles comprise at least one of sand, lightweight proppant (LWP), ultra-lightweight proppant (ULWP), and fly ash.

16. The method of claim 13, wherein the fracturing fluid further comprises second proppant particles that do not comprise coke, and wherein the method comprises, for each of the at least the portion of the plurality of stages, introducing the fracturing fluid comprising the carrier fluid, the coke proppant particles, and the second proppant particles into the subterranean formation during at least a portion of a pad phase of a hydraulic fracturing operation, as well as during at least a portion of a remainder of the hydraulic fracturing operation.

17. The method of claim 16, wherein the second proppant particles comprise at least one of sand, lightweight proppant (LWP), ultra-lightweight proppant (ULWP), and fly ash.

18. The method of claim 1, wherein the carrier fluid comprises water.

19. The method of claim 1, wherein the carrier fluid is substantially free of water.

20. The method of claim 1, wherein the fracturing fluid further comprises at least one of an acid, a biocide, a breaker, a corrosion inhibitor, a crosslinker, a friction reducer, a high-viscosity friction reducer, a gel, a crosslinked gel, an oxygen scavenger, a pH control additive, a scale inhibitor, a surfactant, a weighting agent, an inert solid, a fluid loss control agent, an emulsifier, an emulsion thinner, an emulsion thickener, a viscosifying agent, a foaming agent, a stabilizer, a chelating agent, a mutual solvent, an oxidizer, a reducer, and a clay stabilizing agent.

21. A hydrocarbon well, comprising:
a wellbore that extends within a subterranean formation, wherein the wellbore comprises a lateral section of at least 1,000 feet in length as measured from a heel of the wellbore to a toe of the wellbore;
a production casing string that extends within the lateral section of the wellbore;
perforation clusters formed within the production casing string;
hydraulic fractures formed in the subterranean formation proximate to the perforation clusters; and
coke proppant particles positioned within at least a portion of the hydraulic fractures, wherein the at least the portion of the hydraulic fractures comprises one of the hydraulic fractures that is formed in the subterranean formation proximate to one of the perforation clusters that is closest to the toe the wellbore.

22. The hydrocarbon well of claim 21, wherein the lateral section is at least 10,000 feet in length.

23. The hydrocarbon well of claim 21, wherein the coke proppant particles comprise at least one of:
fluid coke;
flexicoke;
delayed coke;
thermally post-treated coke;
pyrolysis coke; and
coal-derived coke.

24. The hydrocarbon well of claim 21, wherein the hydrocarbon well further comprises second proppant particles that do not comprise coke within at least a portion of the hydraulic fractures.

25. A hydrocarbon well, comprising:
a wellbore that extends within a subterranean formation;
a production casing string that extends within at least a portion of the wellbore;
a plurality of stages within the production casing string, wherein each of the plurality of stages comprises a stage length of at least 200 feet;
perforation clusters formed within each of the plurality of stages;
hydraulic fractures formed in the subterranean formation proximate to the perforation clusters; and
coke proppant particles positioned within at least a portion of the hydraulic fractures, wherein the at least the portion of the hydraulic fractures comprises one of the hydraulic fractures that is formed in the subterranean formation proximate to one of the perforation clusters that is furthest downstream within a corresponding stage.

26. The hydrocarbon well of claim 25, wherein the stage length is at least 400 feet.

27. A hydrocarbon well, comprising:
a wellbore that extends within a subterranean formation;
a production casing string that extends within at least a portion of the wellbore;
a plurality of stages within the production casing string;
at least 6 perforation clusters formed within each of the plurality of stages;
hydraulic fractures formed in the subterranean formation proximate to the perforation clusters; and
coke proppant particles positioned within at least a portion of the hydraulic fractures, wherein the at least the portion of the hydraulic fractures comprises one of the hydraulic fractures that is formed in the subterranean formation proximate to one of the perforation clusters that is furthest downstream within a corresponding stage.

28. The hydrocarbon well of claim 27, comprising at least 10 perforation clusters formed within each of the plurality of stages.
